(19) United States
(12) Patent Application Publication
(10) Pub. No.: US 2019/0066051 A1
(43) Pub. Date: Feb. 28, 2019

(54) MESSAGE THREAD WORKFLOW

(71) Applicant: Moxtra Inc., Los Gatos, CA (US)

(72) Inventor: He Huang, San Jose, CA (US)

(21) Appl. No.: 15/685,400

(22) Filed: Aug. 24, 2017

(51) Int. Cl. G06Q 10/10; H04L 12/58

(52) U.S. Cl. CPC G06Q 10/103; H04L 51/08; H04L 51/04; H04L 51/16; H04L 51/24

(57) ABSTRACT

Technology is disclosed for managing workflow and collaboration within message threads (“the technology”). In various embodiments, the technology provides a thread object service whereby message threads consist of thread objects of various types, including data file, document page, document signature, meeting, message, page comment and to-do objects. The thread objects may be posted independently in a message thread, or associated as replies to any other previously-posted thread objects in a message thread. The technology provides an object action service whereby users take actions that are associated with thread objects in a message thread, and that are presented in the message thread in conjunction with the affected thread object. User actions include actions relating to annotations, attachments, bookmarks, checklists, clips (audio and video clips), comments, due dates, meetings, signatures and to-dos. Further, the technology provides for object layers. An object layer for a thread object consists of the thread object replies and object actions associated with that thread object. The technology provides for a message thread service whereby thread objects are presented in a message thread in conjunction with their object layers. The message thread service also presents any thread objects associated with a user in a tracking list for that user.

### FIELD OF THE DISCLOSURE

The disclosure relates to electronic communications and workflow management, and more specifically to workflow and collaboration using a message thread architecture.

### BACKGROUND

Current message threading services enable users to communicate in virtual conversations by visually grouping messages with their replies, creating message threads. Message threading is extremely popular in a wide variety of products, applications and services, such as email, text messaging, and chat applications. Messaging threading is used in, e.g., Facebook, Inc.'s Messenger, Slack Technologies, Inc.'s Slack®, Cisco Systems, Inc.'s Spark™, Altassian Corporation PLC's HipChat® and RingCentral, Inc.'s Glip® offerings. Message threading services are increasingly being used, not only in social but, in business, contexts.

While messaging threading is a popular way to discuss topics, the aforementioned applications offer no sufficient way to reflect how conversations happen in the real world. Message threading platforms are particularly deficient in effecting productive, real world conversations directed to workflow. Business teams are increasingly using message threading to collaborate on their work. Businesses need to be able to integrate messaging as real-time, interactive, ‘conversation’ in their workflow to achieve enhanced productivity. When teams meet to discuss projects, the team members do more than exchange messages or statements. Team members share annotated notes, schedule follow-up meetings, assign tasks and track assignments, place documents on a table and refer to specific pages, sign necessary documents, agree to action plans, give direct feedback to specific remarks or proposed documents, among other things. The disclosed invention brings these workflow management and collaboration capabilities to message threading services and within the message thread itself. All this work can be done within a message thread.

Heretofore, message threading services have prevented users from, inter alia, responding to a specific message by structured and/or unstructured data formats; attaching to-dos; signing required documents; annotating documents; setting due dates; requesting receipts; keeping track of responses in rich media fashion; getting quick review and feedback; obtaining fast approvals; assigning tasks based on particular comments; quickly bringing in a document and making it a part of the conversation. Furthermore, existing messaging platforms offer no good way to keep audit trails, or to bookmark threads for future reference.

For example, the disclosed invention allows users to share annotated notes, schedule a meeting, assign tasks and to track activities—all without leaving the message threading service. The invention allows users to conduct these tasks efficiently and within the operative message thread.

### SUMMARY

Technology is disclosed for managing workflow and collaboration in message threads (“the technology”). In various embodiments, the technology provides a message thread workflow service that creates, manages and presents message threads to users. The message threads consist of thread objects of various types, including message objects, data file objects, document page objects, page comment objects, document signature objects, meeting objects and to-do objects. The thread objects may be used to initiate a message thread, post to a message thread, and/or to post a reply in a message thread, consistent with various embodiments.

In various embodiments, the technology provides for object actions that are associated with a thread object, and that facilitate related workflow and collaboration. The object actions may be presented, consistent with various embodiments, in a message thread and in conjunction with the previously-posted thread object identifier. For example, actions may relate to annotations, attachments, bookmarks, checklists, clips (audio and video clips), comments, due dates, meetings, signatures and to-dos. In various embodiments, checklists are made more efficient through check list templates. Existing check lists may be saved as a checklist template. New check lists may be created from a checklist template.

In various embodiments, the technology creates, manages and presents tracking lists for individual users of an embodiment of the message threading service. Tracking lists provide a list of a user's active thread objects. For example, active thread objects may be objects wherein the user is referenced (e.g., “@username”), wherein the user's signature is required, wherein the user is assigned a to-do, or wherein thread objects bookmarked by users are shown. The user may also be sent push notifications and/or other relevant alerts associated with the user's active thread objects. In some embodiments, a user's tracking list are presented as a side bar, along one side of the user's currently-viewed message thread.

### BRIEF DESCRIPTION OF THE DRAWINGS

The drawings described herein are for illustrative purposes only of selected embodiments and not all possible implementations and are not intended to limit the scope of the present disclosure.

FIG. 1 is a block diagram illustrating an environment in which the technology may operate in various embodiments.

FIG. 2 is a block diagram illustrating an environment for managing message thread workflow using a thread object service, consistent with various embodiments.

FIG. 3 is an example of a message thread of FIG. 2 containing an example message object and data file object of FIG. 2, consistent with various embodiments.

FIG. 4 is an example of a message thread of FIG. 2 containing an example to-do object and meeting object of FIG. 2, consistent with various embodiments.

FIG. 5 is an example of a message thread of FIG. 2 containing an example page comment object, document signature object and data file object of FIG. 2, consistent with various embodiments.

FIG. 6 is a block diagram illustrating the relationship of thread objects to their associated object actions and replies, consistent with various embodiments.

FIG. 7 is a block diagram illustrating an environment for managing message thread workflow using a thread object service and an object action service, consistent with various embodiments.

FIG. 8 is an example of a message thread of FIG. 7 with an example to-do object, message object associated as a reply to a previously-posted thread object, and due date object action, consistent with various embodiments.

FIG. 9 is an example of a to-do object action, edit, of the to-do object of FIG. 8, consistent with various embodiments.

FIG. 10 is an example of a message thread of FIG. 7 with a meeting object and its associated object action, consistent with various embodiments.

FIG. 11 is an example of a meeting object action, view, the meeting object of FIG. 10, consistent with various embodiments.

FIG. 12 is a block diagram illustrating an environment for managing message thread workflow using a thread object service, an object action service and a message thread service, consistent with various embodiments.

FIG. 13 is an example of a presentation of a message thread of FIG. 12, consistent with various embodiments.

FIG. 14 is an example of a presentation of a tracking list of FIG. 12, consistent with various embodiments.

FIG. 15 is a block diagram of a system for a message thread workflow service of FIG. 1, consistent with various embodiments.

FIG. 16 is a flow diagram of a process of presenting a new to-do object, consistent with various embodiments.

FIG. 17 is a flow diagram of a process of presenting a new page comment object, consistent with various embodiments.

FIG. 18 is a flow diagram of a process of presenting a new meeting object, consistent with various embodiments.

FIG. 19 is a flow diagram of a process of presenting a new document signature object in a message thread, consistent with various embodiments.

FIG. 20 is a flow diagram of a process of performing a due date object action, create due date, associated with a thread object in a message thread, consistent with various embodiments.

FIG. 21 is a flow diagram of a process of performing a meeting object action, start meeting, associated with a meeting object in a message thread, consistent with various embodiments.

FIG. 22 is a flow diagram of a process of presenting a tracking list associated with a user, consistent with various embodiments.

FIG. 23 is a block diagram illustrating component of an apparatus that may perform various operations described by the technology.

### DEFINITIONS

Message Thread: a grouping of related thread objects and their object layers.

Thread Object: an item of information that a user may post to a message thread. A thread object is one of the following types: message object, data file object, document page object, page comment object, document signature object, meeting object, or to-do object. Thread objects have attributes, including attributes which may be set and/or modified by users.

Reply: a thread object of any type posted to a message thread in association as a reply to any previously-posted thread object of any type.

Object Action: an action that a user may request to be performed with respect to any previously-posted thread object. An object action is one of the following types: annotate object actions, attachment object actions, bookmark object actions, checklist object actions, clip object actions, comment object actions, due data object actions, meeting object actions, signature object actions, or to-do object actions. Object actions have attributes, including attributes which may be set and/or modified by users.

Object Layer: the set of replies and object actions associated with a posted thread object.

Requesting User: an attribute that identifies the user who requested a thread object to be created, or an object action to be performed.

Mentioned User: an attribute that identifies which users are associated with a thread object or an object action.

### Thread Object Types

Data File Object: a type of thread object which has one or more of the following attributes: thread object identifier, request timestamp, requesting user, one or more mentioned users, previously-posted thread object identifier, message (text or voice), data file identifier, data file location and data file format.

Document Page Object: a type of thread object which has one or more of the following attributes: thread object identifier, request timestamp, requesting user, one or more mentioned users, previously-posted thread object identifier, message (text or voice), one or more page numbers, document file identifier, document file location, and document file format.

Document Signature Object: a type of thread object which has one or more of the following attributes: thread object identifier, request timestamp, requesting user, one or more mentioned users, previously-posted thread object identifier, message (text or voice), one or more signers, one or more signer statuses, signing order, document status, document file identifier, document file location, and document file format.

Meeting Object: a type of thread object which has one or more of the following attributes: thread object identifier, request timestamp, requesting user, one or more mentioned users, previously-posted thread object identifier, message (text or voice), host, one or more invitees, date, time, duration, agenda, meeting identifier, phone number, URL, record setting, document file identifier, document file location, and document file format.

Message Object: a type of thread object which has one or more of the following attributes: thread object identifier, request timestamp, requesting user, one or more mentioned users, previously-posted thread object identifier, message (text or voice).

Page Comment Object: a type of thread object which has one or more of the following attributes: thread object identifier, request timestamp, requesting user, one or more mentioned users, previously-posted thread object identifier, message (text or voice), comment, page position, page number, document file identifier, document file location, and document file format.

To-Do Object: a type of thread object which has one or more of the following attributes: thread object identifier, request timestamp, requesting user, one or more mentioned users, previously-posted thread object identifier, message (text or voice), description, one or more assignees, due date, reminder schedule, status, data file identifier, data file location and data file format.

### Object Action Types

Annotate Object Action: a type of object action associated with document page objects, which has one or more of the following attributes: object action identifier, request timestamp, requesting user, one or more mentioned users, previously-posted thread object identifier, document file identifier, document file location, page, page position, annotation type and annotation. An annotate object action is one of the following types: create, delete, edit and view.

Attachment Object Action: a type of object action associated with data file, document page, document signature, meeting, message and to-do objects, which has one or more of the following attributes: object action identifier, request timestamp, requesting user, one or more mentioned users, previously-posted thread object identifier, data file identifier, data file location and data file format. Data files of multiple formats can be attached to (associated with) a thread object. An attachment object action is one of the following types: attach, detach and open.

Bookmark Object Action: a type of object action associated with data file, document page, document signature and message objects, which has one or more of the following attributes: object action identifier, request timestamp, requesting user, one or more mentioned users, previously-posted thread object identifier and bookmark location. A bookmark object action is one of the following types: bookmark and remove bookmark.

Checklist Object Action: a type of object action associated with data file, document page, document signature, message and to-do objects, which has one or more of the following attributes: object action identifier, request timestamp, requesting user, one or more mentioned users, previously-posted thread object identifier, one or more subtasks, one or more subtasks' statuses, and title. A checklist object action is one of the following types: create, create from template, delete, edit, save as template, and view.

Clip Object Action: a type of object action associated with document page objects, which has one or more of the following attributes: object action identifier, request timestamp, requesting user, one or more mentioned users, previously-posted thread object identifier, audio or video data file identifier, audio or video data file location, and audio or video data file format. Audio and video data files may be of multiple formats. A clip object action is one of the following types: attach, detach and open.

Comment Object Action: a type of object action associated with data file, document page, page comment, document signature, meeting and to-do objects, which has one or more of the following attributes: object action identifier, request timestamp, requesting user, one or more mentioned users, previously-posted thread object identifier, and comment. A comment object action is one of the following types: create, delete, edit and view.

Due Date Object Action: a type of object action associated with thread objects of any type, which has one or more of the following attributes: object action identifier, request timestamp, requesting user, one or more mentioned users, previously-posted thread object identifier, message (text or voice), due date, status and one or more notification settings. A due date object action is one of the following types: create, delete, edit and view.

Meeting Object Action: a type of object action associated with meeting objects, which has one or more of the following attributes: object action identifier, request timestamp, requesting user, one or more mentioned users, previously-posted thread object identifier, message (text or voice), and one or more access methods. A meeting object action is one of the following types: delete, edit, join, record, start and view.

Signature Object Action: a type of object action associated with document signature objects, which has one or more of the following attributes: object action identifier, request timestamp, requesting user, one or more mentioned users, previously-posted thread object identifier, one of one or more signers and one of one or more signer responses. A signature object action is one of the following types: accept, decline and execute.

To-Do Object Action: a type of object action associated with to-do objects, which has one or more of the following attributes: object action identifier, request timestamp, requesting user, one or more mentioned users, previously-posted thread object identifier, one or more to-do object attributes, and one or more to-do object attribute values. A to-do object action is one of the following types: delete, edit and view.

### DETAILED DESCRIPTION

### Environment for Message Thread Workflow

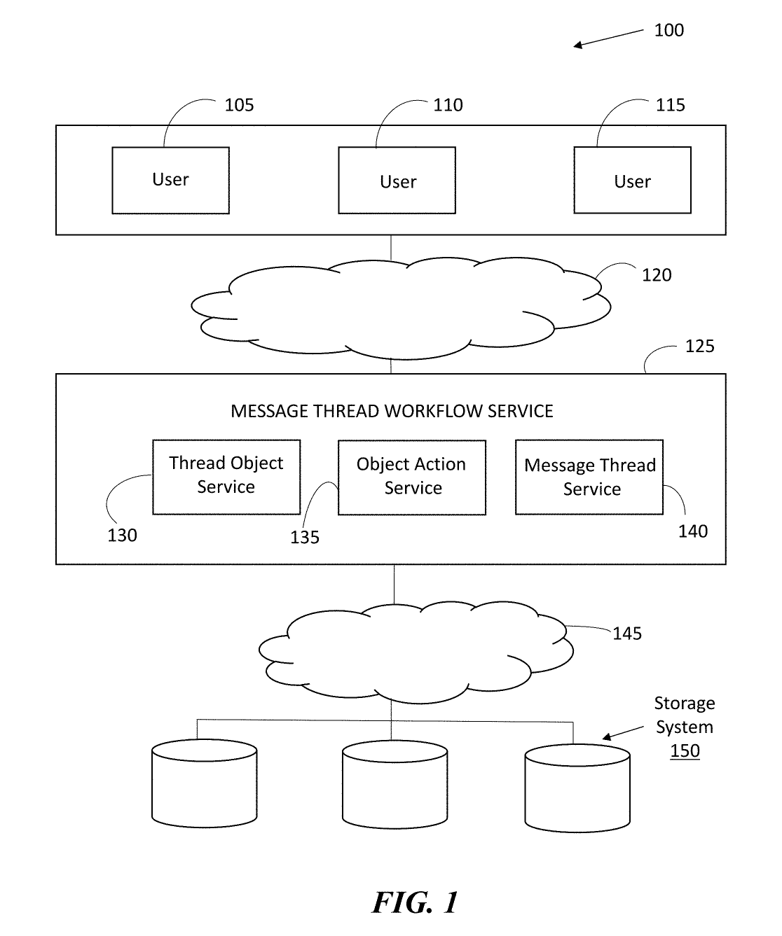

Technology is disclosed for managing workflow and collaboration within message threads (“the technology”). Several embodiments of the technology are described in more detail in reference to the figures. Turning to FIG. 1, FIG. 1 is a block diagram illustrating an environment 100 in which the technology may operate in various embodiments. The environment 100 includes a message thread workflow service 125 that provides a set of services, including services such as a thread object service 130, an object action service 135 and a message thread service 140 to a set of users, e.g., user 105, user 110 and user 115. The set of users may access the message thread workflow service 125 via a communication network 120. Further, the set of users may access the message thread workflow service 125 using a variety of devices, including a desktop, a laptop, a smart phone, or a tablet PC.

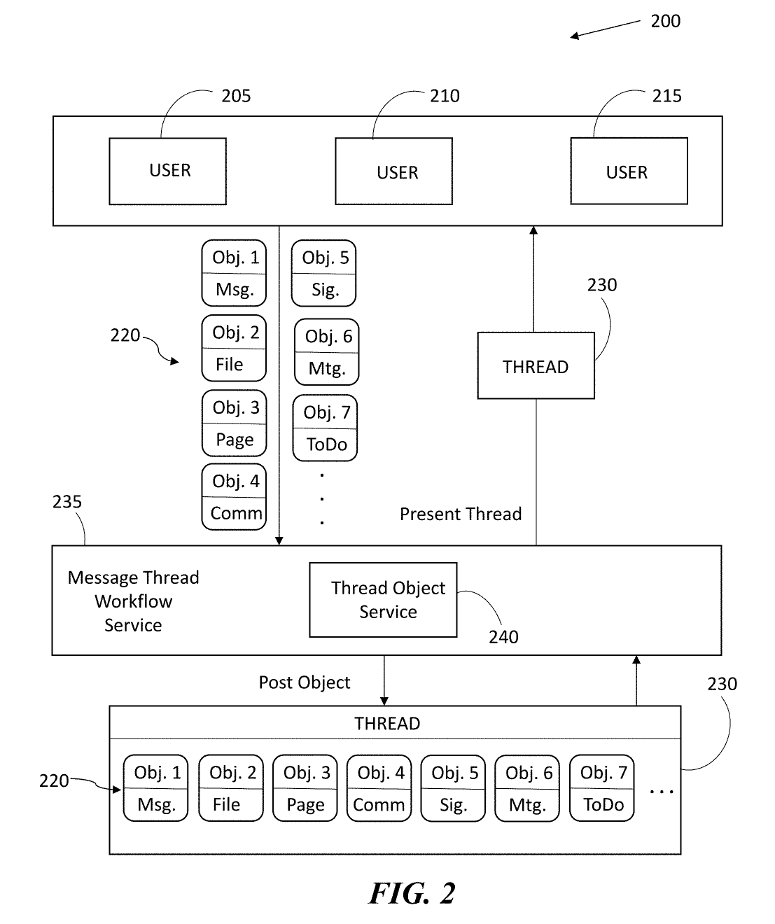

In various embodiments, the message thread workflow service 125 creates, updates, stores and presents one or more message threads to a set of users, such as users 105, 110 and 115. A message thread consists of one or more thread objects of multiple types, any actions performed with respect to any of the one or more thread objects, and any thread objects of multiple types posted as replies to any of the one or more thread objects. Message threads may be presented or accessed using a variety of devises regardless of a platform of the devices. In some embodiments, the set of users may access the message thread workflow service 125 using a web browser installed on a device. Further details regarding creating, managing and presenting a message thread are described with reference to at least FIGS. 2, 6-7, 12 and 15-23.

Referring back to FIG. 1, the thread object service 130 allows the users to create a thread object of a multiple types to be posted to a message thread, consistent with various embodiments. Thread objects may be posted to a message thread unassociated with any previously-posted thread object in the message thread, or may be posted to a message thread associated as a reply to any previously-posted thread object in a message thread. The replies to a thread object may be associated with that thread object by way of its object layer. Further, the replies associated with a thread object may be presented in a message thread in conjunction with that thread object. Thread object types may include such types as message objects for typed or voice-recorded messages; data file objects for data files of multiple formats; document page objects for one or more pages of documents; page comment objects for comments related to specific locations on specific pages of documents; document signature objects for documents requiring signature; meeting objects for scheduling and managing meetings; and to-do objects for creating and managing to-dos. Further details regarding the thread object service 130 are described with reference to at least FIGS. 2, 6-7, 12 and 15-23.

The disclosed invention's ability to post these new and diverse types of thread objects to a message thread is critical to enabling its novel functionality directed to workflow and collaboration. The invention's ability to post these new and diverse types of thread objects as replies to any previously-posted thread object in a message thread is also a key, enabling feature. Replies in a message thread are no longer necessarily appended chronologically to the end of a message thread, and are no longer necessarily a text message.

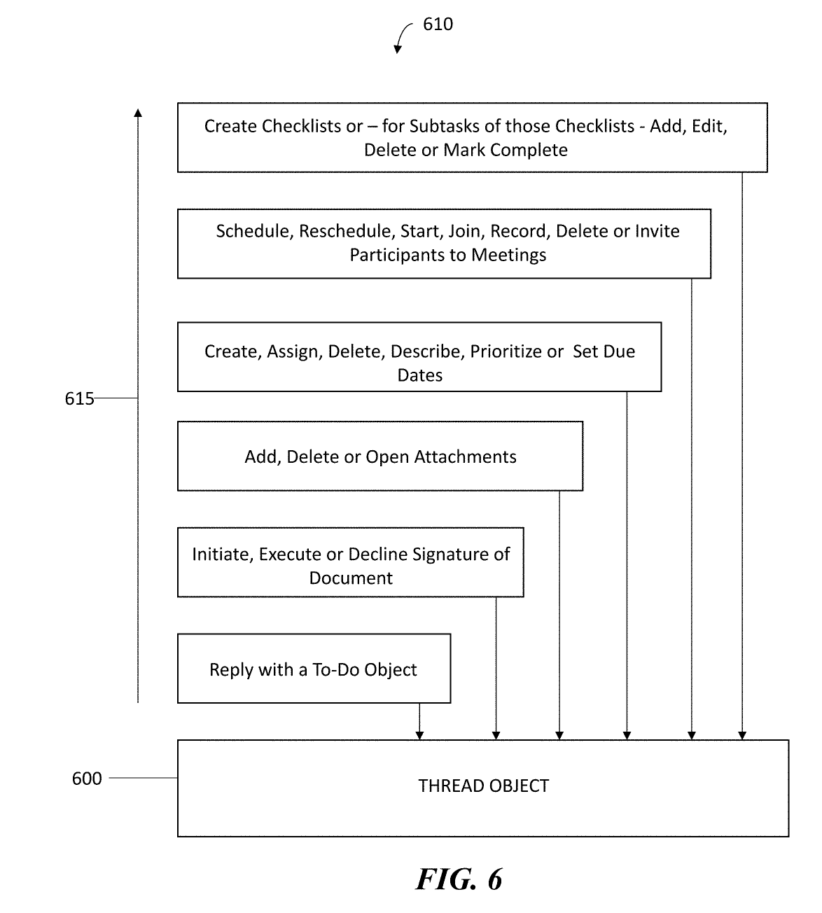

Referring back to FIG. 1, object action service 135 allows the users to request actions of multiple types to be performed and associated with any previously-posted thread object in a message thread, consistent with various embodiments. The actions and their related activity may be associated with a thread object by way of the thread object's object layer. Further, the actions and their related activity associated with a thread object may be presented in a message thread in conjunction with that thread object. In various embodiments, types of object actions may include such actions as annotate, attach, bookmark, comment, mention and sign. Types of object actions may also relate to such things as annotations (e.g., create), attachments (e.g., open), bookmarks (e.g., remove), checklists (e.g., add action item), clips (e.g., attach audio clip), comments (e.g., view), due dates (e.g., set), meetings (e.g., start), signature (e.g., sign), and to-dos (e.g., edit). In various embodiments, object actions for checklists may be made more efficient through checklist templates. Existing checklists may be saved as a checklist template. New checklists may be created from a checklist template. Further details regarding object action service 135 are described with reference to at least FIGS. 6-7, 12 and 15-23.

The disclosed invention's ability to perform these new and diverse types of object actions associated with any previously-posted thread object in a message thread is critical to enabling its novel functionality directed to workflow and collaboration. These object actions allow for enhanced, flexible, real-time workflow management.

Referring back to FIG. 1, message thread service 140 stores and presents message threads and tracking lists to users, consistent with various embodiments. The message threads and tracking lists may be configured to be stored in storage system 150 accessible via a communication network 145. Storage system 150 stores message threads, including thread objects and their associated replies and actions, and tracking lists. Storage system 150 may include a set of databases. In various embodiments, storage system 150 may be configured as a cloud storage system that may be distributed among different geographical locations. The thread objects and object actions associated with a particular message thread may be stored in the same database of storage system 150 or different databases of storage system 150. Further, storage system 150 may be set up separate from message thread workflow service 125, for example, on different machines, different geographical locations, etc.

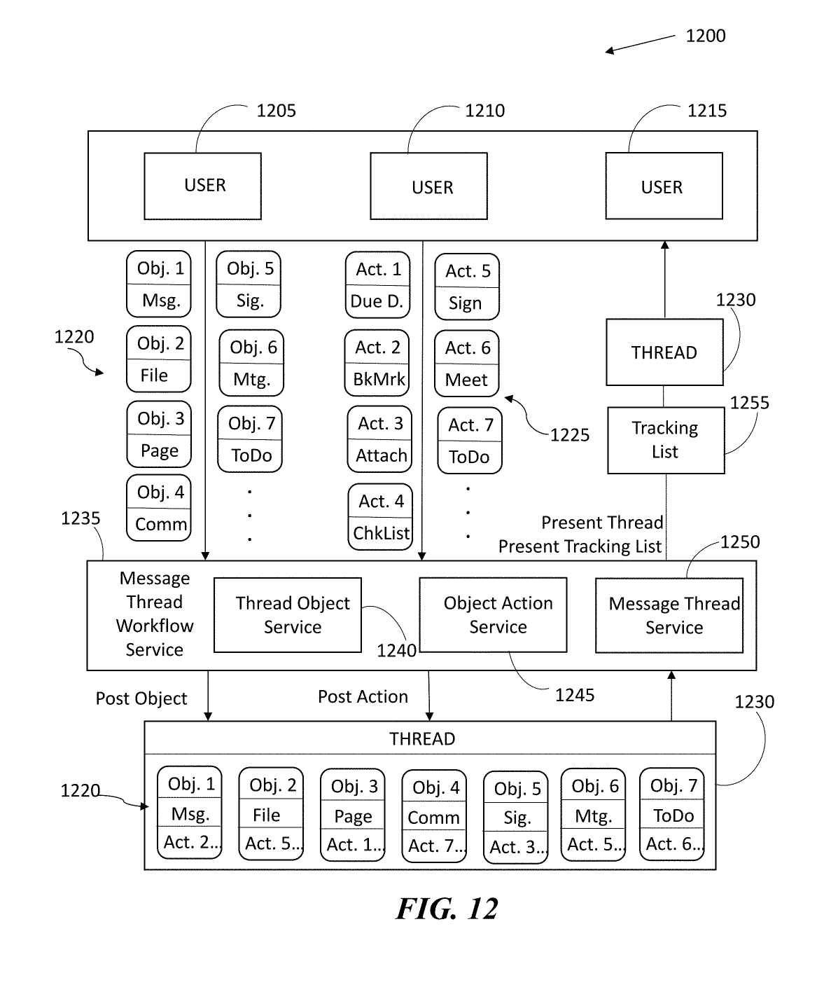

Message thread service 140 presents message threads, which include thread objects with their associated object layers consisting of user replies and actions, and tracking lists. Tracking lists provide a list of a user's active message thread objects. For example, an active message thread object may be an object where the user is mentioned (e.g., “@username”), the user's signature is required, the user is assigned a to-do, or where the user created bookmarks. The user may also be sent push notifications and/or other relevant alerts associated with the user's active thread objects. In some embodiments, a user's tracking list may be presented as a side bar, along one side of the user's currently-viewed message thread. Further details regarding message thread service 140 are described with reference to at least FIGS. 12 and 15-23.

Message thread workflow service 125 may be implemented in a variety of configurations. One typical configuration may include an online configuration in which message thread workflow service 125 is implemented in a distributed network, for example, LAN, WAN, or Internet. The users access message thread workflow service 125 over a communication network such as network 120. In various embodiments, message thread workflow service 125 may also be implemented in server client configuration in which an application corresponding to the client portion may be installed on the device of the user. The users may access message thread workflow service 125 using a web browser or a message thread workflow service application (also referred to as “message thread workflow app” or “app”) installed on the device of the user.

### Thread Object Service

Turning now to FIG. 2, FIG. 2 is a block diagram, consistent with various embodiments, illustrating an environment for managing workflow and collaboration in a message thread using a message thread workflow service and a thread object service, both of FIG. 1. Message thread workflow service 235 of environment 200 may be similar to message thread workflow service 125 of FIG. 1. Thread object service 240 of environment 200 may be similar to thread object service 130 of FIG. 1.

Users, such as user 205, user 210 and user 215, may create, consistent with various embodiments, multiple thread objects 220 in multiple types, using the thread object service 240. The types may include, for example: (a) message objects (“Obj. 1”), (b) data file objects (“Obj. 2”), (c) document page objects (“Obj. 3”), (d) page comment objects (“Obj. 4”), (e) document signature objects (Obj. 5”), (f) meeting objects (“Obj. 6”) and (g) to-do objects (“Obj. 7”). Users can, for example, create: (i) message objects to post a typed or voice-recorded message to a message thread; (ii) data file objects to post a data file of multiple formats, such as, e.g., Microsoft Corporation's Word format, Microsoft Corporation's Excel® format, Microsoft Corporation's PowerPoint® format, Joint Photographic Experts Group (.jpg) format, Adobe Systems Incorporated's portable document (.pdf) format, Apple Inc.'s QuickTime® (.mov) format, Apple Inc.'s Keynote® format, graphics interchange (.gif) format, bitmap (.bpm) format, and Microsoft Corporation's text (.txt) format; (iii) document page objects to post one or more pages of a document; (iv) page comment objects to place a comment on a particular position of a particular page of a document; (v) document signature objects to post a document that require signature(s) and initiate an approval process; (vi) meeting objects to post a meeting notification and to initiate a meeting process (e.g., scheduling, joining, declining, etc.); (vii) and to-do objects for posting to-dos and initiating a tracking process; and (viii) thread objects of any type for replying to any previously-posted thread object in a message thread.

Referring back to FIG. 2, consistent with various embodiments, thread object service 240 may post the created thread objects 220 in a message thread, such as message thread 230, which was indicated by the user. Users may post a thread object unassociated with any other thread objects in a message thread. For example, a user may post a meeting object that notifies selected users of a scheduled meeting. Users may also post a thread object associated as a reply to any previously-posted thread object in a message thread. For example, a user may post a to-do object, which creates a to-do, assigns the to-do and sets a due date, as a reply to a previously-posted meeting object.

Message threads, such as message thread 230, may be accessed using a variety of devices, including a desktop, a laptop, a smart phone, or a tablet PC. Message threads, such as thread 230, may be accessed using a web browser installed on the device. In some embodiments, the web browser may include a script for rendering message thread 230 on the device. Further, message workflow service 235 is platform agnostic, that is, the users make access the message threads, such as message thread 230, from devices running on operating systems, such as Microsoft Corporation's Windows, Apple Inc.'s macOS® and iOS®, and Google Inc.'s Chrome OS™ operating systems.

In various embodiments, users, such as user 205, user 210 and user 215, may create more than one thread object, such as one of the created thread objects 220, and may post those thread objects 220 to more than one message thread, such as message thread 230.

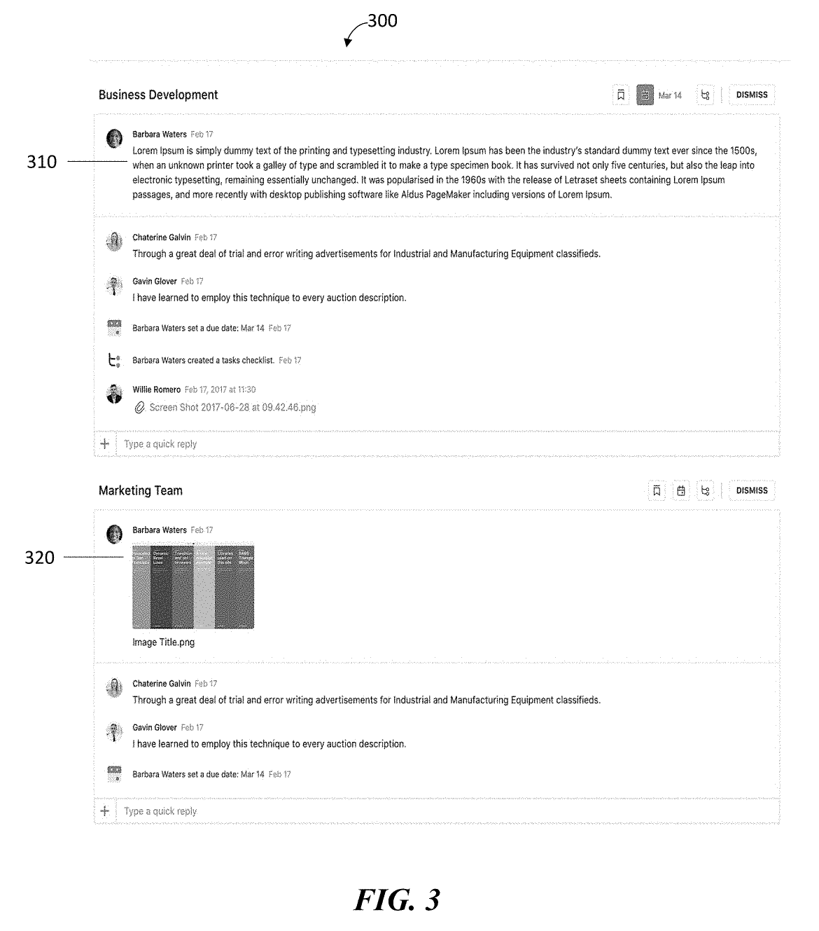

Turning now to FIG. 3, FIG. 3 is an example of a message thread, message thread 300, presented to users, consistent with various embodiments. Message thread 300 may be similar to message thread 230 of FIG. 2. Message thread 300 contains text/voice object 310 with a text message (“Lorem lpsum is simply dummy text . . . ”), which may be similar to one of the thread objects 220 in FIG. 2, specifically “Obj. 1”. Message thread 300 also contains data file object 320 with a data file (“Image Title.png”), consistent with various embodiments. Data file object 320 may be similar to one of the thread objects 220 in FIG. 2, specifically “Obj. 2”.

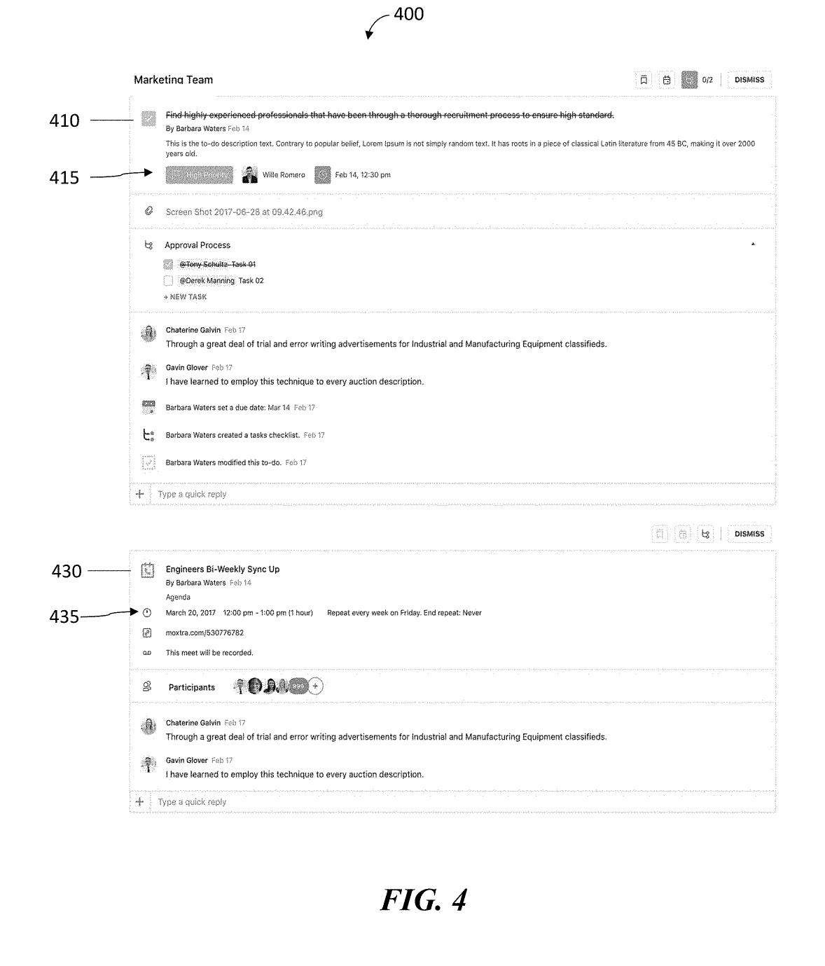

Turning now to FIG. 4, FIG. 4 is an example of a message thread, message thread 400, presented to users, consistent with various embodiments. Message thread 400 may be similar to the message thread 230 of FIG. 2. Message thread 400 contains to-do object 410, which may be similar to one of the thread objects 220 in FIG. 2, specifically “Obj. 7”. To-do object 410 contains attributes 415, including priority, assignee, and due date and time, which may be set and/or modified by users. Some embodiments may indicate a to-do is completed by striking through the to-do object's title and displaying a checked box icon. To-do object 410, for example, has similar indications of being completed. Message thread 400 also contains meeting object 430, which may be similar to one of the thread objects 220 in FIG. 2, specifically “Obj. 6”. Meeting object 430 contain attributes 435, including scheduled date and time, duration and repetition which may set and/or modified by users.

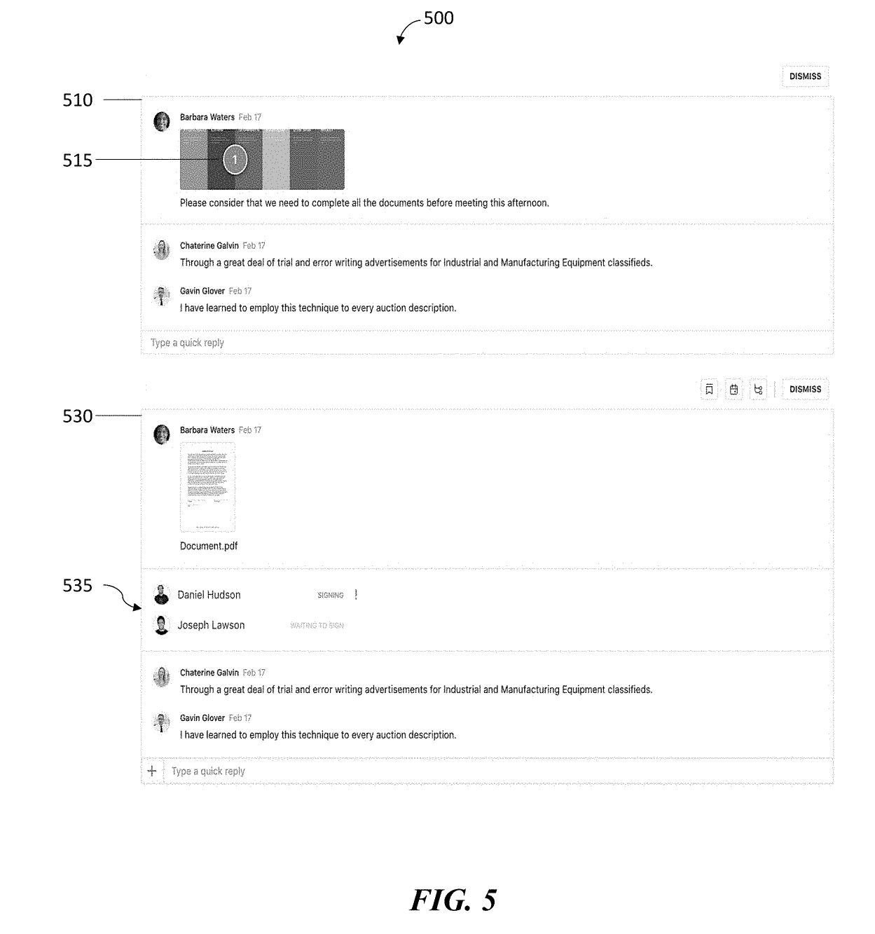

Turning now to FIG. 5, FIG. 5 is an example of a message thread, message thread 500, presented to users, consistent with various embodiments. Message thread 500 may be similar to message thread 230 of FIG. 2. Message thread 500 contains a page comment object 510, which may be similar to one of the thread objects 220 in FIG. 2, specifically “Obj. 4”. In some embodiments, page comment objects may contain page position comments; that is to say a typed user comment associated with a particular position on a particular page of a document. Page comment object 510 contains a comment (“Please consider . . . ”) that is associated with a particular position 515 on the particular page attached to page comment object 510.

Message thread 500 also contains document signature object 530 with a document requiring multiple signatures (“Document.pdf”), consistent with various embodiments. Document signature object 530 may be similar to one of the thread objects 220 in FIG. 2, specifically “Obj. 5”. Document signature object 530 contains attributes 535, including signatories (e.g., “Daniel Hudson”) and signature status (e.g., “waiting to sign”), which may be created and/or updated by users. Message thread 500 also contains data file object 530 with a data file (“Document.zip”), consistent with various embodiments.

### Object Action Service

Turning now to FIG. 6, FIG. 6 is a block diagram, consistent with various embodiments, illustrating the relationship of thread objects to their associated object actions and thread object replies. Thread object 600 may be similar to the thread objects 220 of FIG. 2. As discussed above, users may request multiple actions be performed and associated with any previously-posted thread object. Users may also post multiple thread objects associated as replies to any previously-posted thread object. For example, a user may request one or more actions and replies 610 associated with thread object 600. All users' requested actions, and replies, associated with a particular thread object form the object layer of that thread object. For example, each user action or reply 610 a user with respect to thread object 600 becomes part of object layer 615 of thread object 600. In various embodiments, a thread object's object layer may be presented in a message thread in conjunction with that thread object.

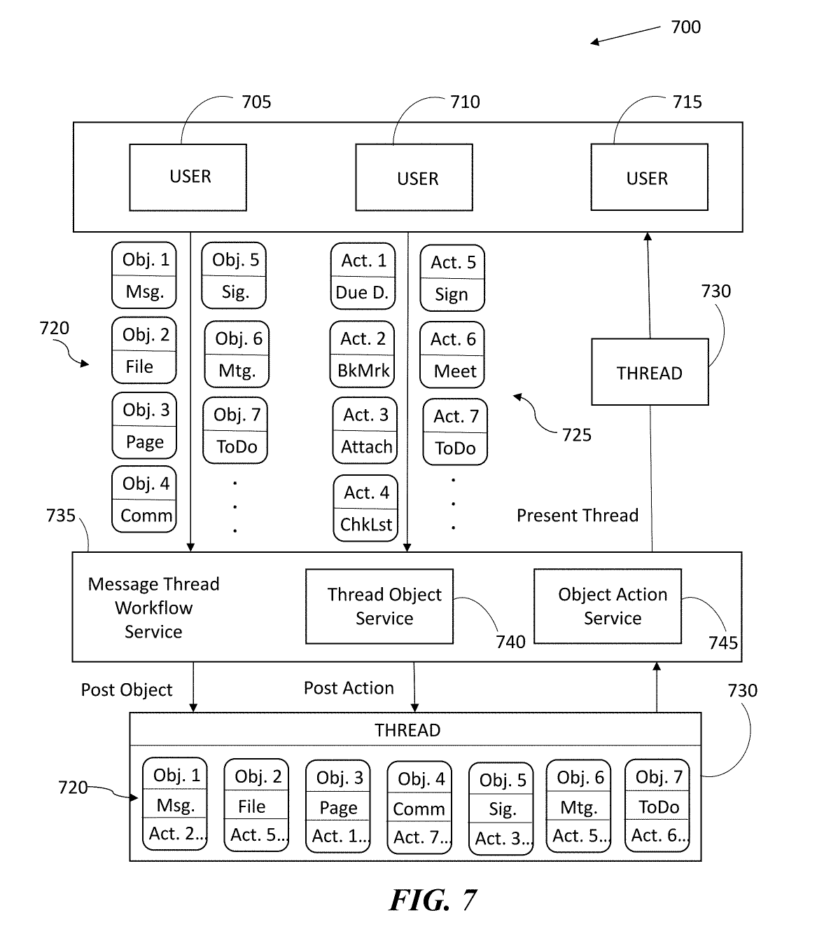

Turning now to FIG. 7, FIG. 7 is a block diagram, consistent with various embodiments, an environment for managing message thread workflow using a thread object service and an object action service. Message thread workflow service 735 of environment 700 may be similar to message thread workflow service 125 of FIG. 1. Thread object service 740 of environment 700 may be similar to thread object service 130 of FIG. 1. Object action service 745 of the environment 700 may be similar to the object action service 135 of FIG. 1.

Users, such as user 705, user 710 and user 715, may request performance of multiple object actions 725, consistent with various embodiments, associated with any previously-posted thread object 720 in any message thread, such as message thread 730, using the object action service 745. The object actions available to be requested, performed and associated with thread objects may relate to, for example: (a) annotations, (b) attachments, (c) bookmarks, (d) checklists, (e) clips (audio and video), (f) comments, (g) due dates, (h) meetings, (i) signatures, and (k) to-dos, consistent with various embodiments.

Users can, for example: (i) create, delete, edit and view annotations associated with page objects; (ii) attach, detach and open data files of multiple types associated with data file, document page, document signature, message, meeting and to-do objects; (iii) bookmark and remove bookmarks associated with data file, document page, document signature and message objects; (iv) create, delete, edit and view checklists (and subtasks of those checklists) associated with data file, document page, document signature, message and to-do objects; (v) attach, detach and open audio or video clips associated with a document page object; (vi) create, delete, edit and view comments associated with data file, document page, page comment, document signature, meeting and to-do objects; (vii) create, delete, edit and view due dates associated with data file, document page, document signature, message and to-do objects; (viii) delete, edit, join, record, start and view meetings associated with meeting objects; (ix) accept, decline and execute signatures associated with document signature objects; and (x) delete, edit (e.g., assignment, description, due date, notifications, priority and status) and view to-dos associated with to-do objects; consistent with various embodiments.

In some embodiments, object actions for checklists may be made more efficient through checklist templates. Existing checklists may be saved as a checklist template. New checklists may be created from a checklist template.

Referring back to FIG. 7, object action service 745 may associate object actions 725 with thread objects 720 in a message thread, such as message thread 730, which was indicated by the user, consistent with various embodiments. Users may request performance of multiple object actions 725 associated with one or more thread objects 720 in a message thread, such as message thread 730. For example, a user may create and post a meeting object that notifies selected users of a scheduled meeting. In another example, a user may reply to a message object, by creating and posting a to-do object that is associated with that message object, and that creates and assigns a to-do with a specified due date.

Message threads, such as message thread 730, may be accessed using a variety of devices, including a desktop, a laptop, a smart phone, or a tablet PC. Message threads, such as message thread 730, may be accessed using a web browser installed on the device. In some embodiments, the web browser may include a script for rendering a message thread 730 on the device. Further, message workflow service 735 is platform agnostic, that is, users may access message threads, such as message thread 730, from devices running on operating systems, such as Microsoft Corporation's Windows, Apple Inc.'s macOS® and iOS®, and Google Inc.'s Chrome OS™ operating systems.

In various embodiments users, such as user 705, user 710 and user 715, may request performance of more than one object action 725 and associate those object actions to more than one thread object 720, which may be in more than one message thread, such as message thread 730.

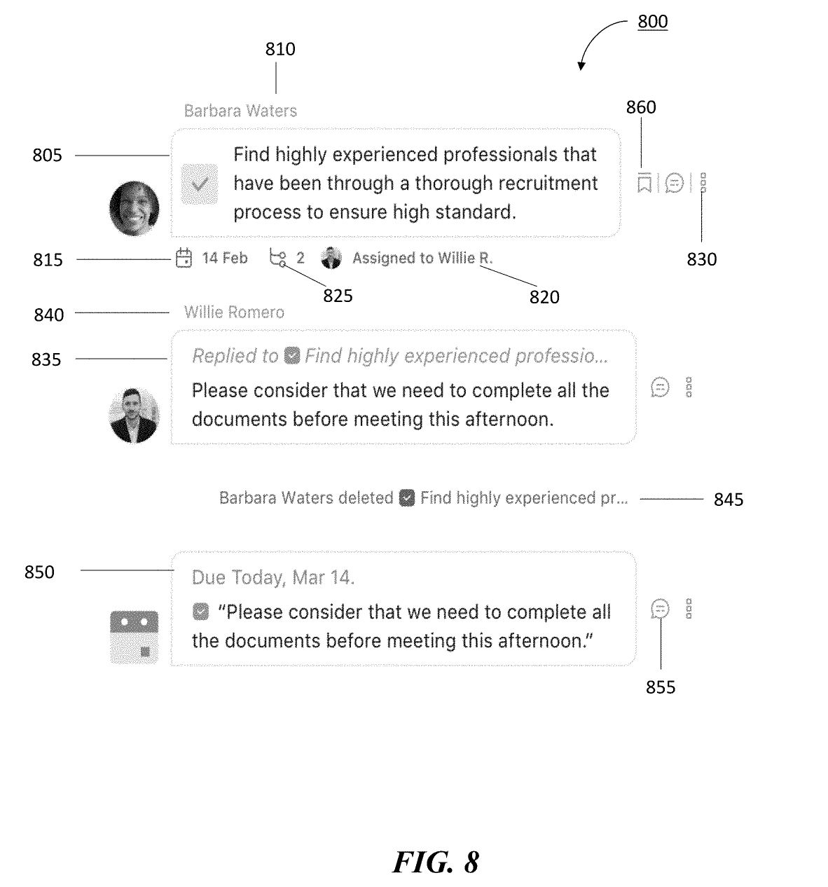

Turning now to FIG. 8, FIG. 8 is an example of a message thread, message thread 800, consistent with various embodiments. Message thread 800 may be similar to message thread 730 of FIG. 7. In this example, the presentation of to-do object 805 indicates to users that to-do object 805 was created by user 810 with due date 815, assignee 820 and associated checklist 825, consistent with various embodiments. Objects, such as to-do object 805, may have a variety of associated object actions available to users. In various embodiments, users may access particular object actions associated with a thread object by clicking on an icon, such as icon 830.

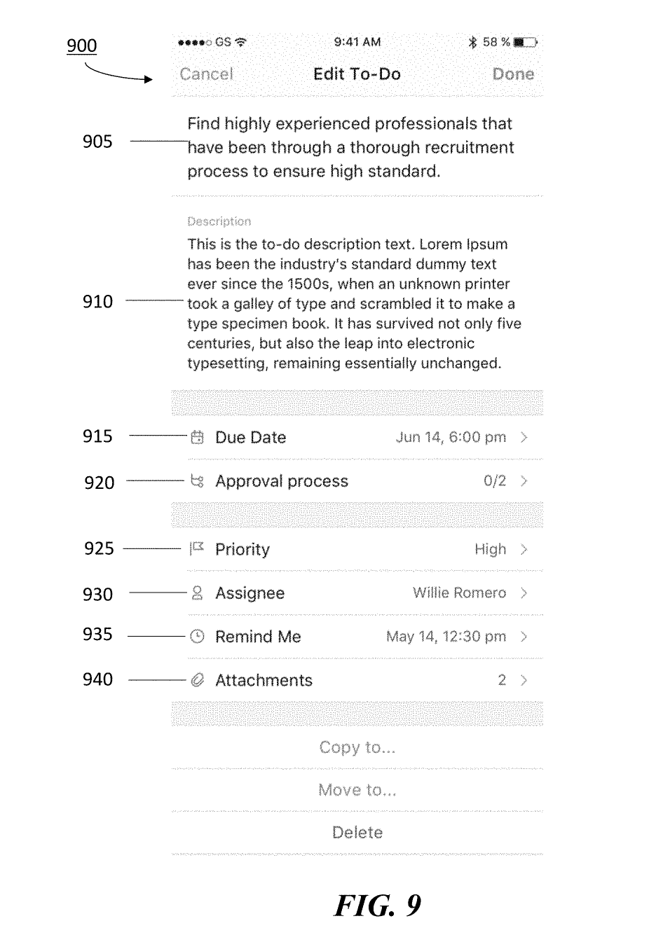

Turning now to FIG. 9, FIG. 9 is an example of an object action (edit), object action 900, associated with to-do objects, consistent with various embodiments. Object action 900 may be similar to one of the object actions 725 in FIG. 7. Users may access object action 900 by way of an icon similar to icon 830 in FIG. 8. In object action 900, users may edit certain attributes of a to-do object, including: title 905, description 910, due date 915, associated checklist 920, priority 925, assignee 930, reminder notifications 935, and associated attachments 940. The associated checklist 920 is, for example, entitled “Approval process”, and has 2 total subtasks with 0 subtasks marked completed (“0/2”), consistent with various embodiments. The associated checklist 920 may be represented in the message thread by icons similar to icon 825 in FIG. 8.

Returning back to FIG. 8, user 840 posted message object 835 (“Please consider . . . ”), associated as a reply to to-do object 805, consistent with various embodiments. Notifications of performed object actions, such as deletion 845 of thread object 805 requested by user 810, may be presented in message thread 800. In various embodiments, object actions, such as due date object action, may be performed in association with thread objects, such as message object 835, and presented in a message thread, such as due date object action 850. Users may request a performance of a comment object action by clicking an icon, such as icon 855, associated with, for example, to-do object 805, message object 835 or due date object action 850. Users may request performance of a bookmark object action by clicking an icon, such as icon 860, associated with, for example, to-do object 805, consistent with various embodiments.

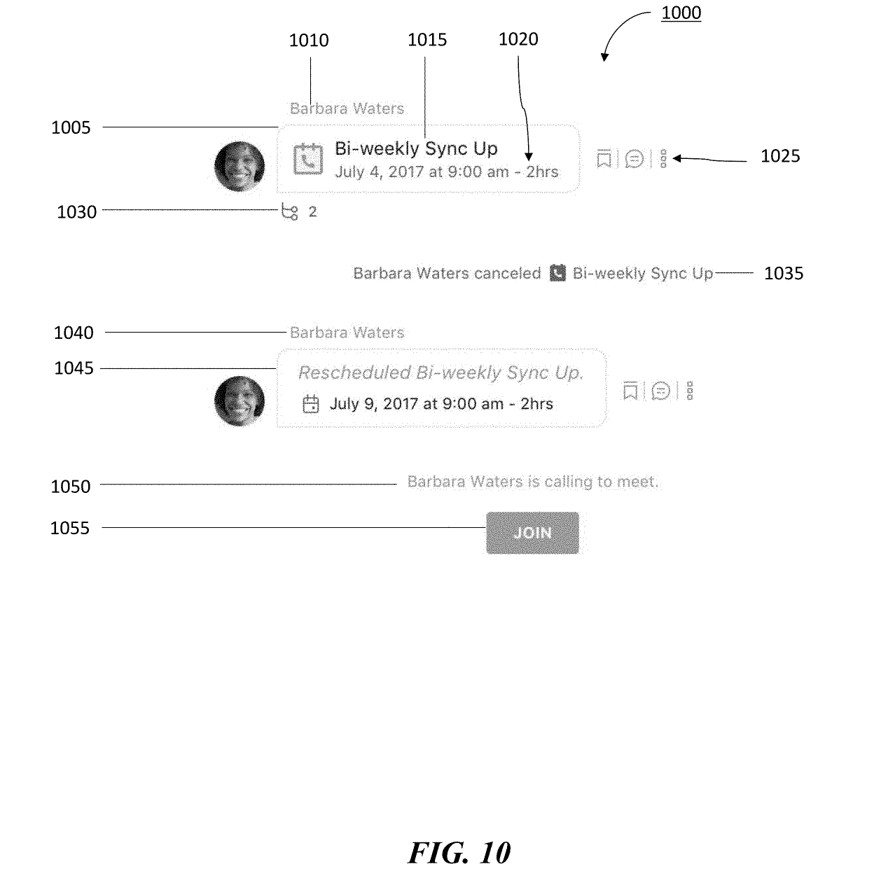

Turning now to FIG. 10, FIG. 10 is an example of a message thread, message thread 1000, consistent with various embodiments. Message thread 1000 may be similar to message thread 730 of FIG. 7. In this example, the presentation of meeting object 1005 in message thread 1000 indicates to users that meeting object 1005 was created by user 1010 with title 1015 and with scheduled date, time and duration 1020, and associated checklist 1030, consistent with various embodiments. Objects, such as meeting object 1005, may have associated object actions available to users. In various embodiments, as discussed above, users may access particular actions associated with a thread object, such as bookmark, comment or object actions, by clicking on an icon, such as icon 1025.

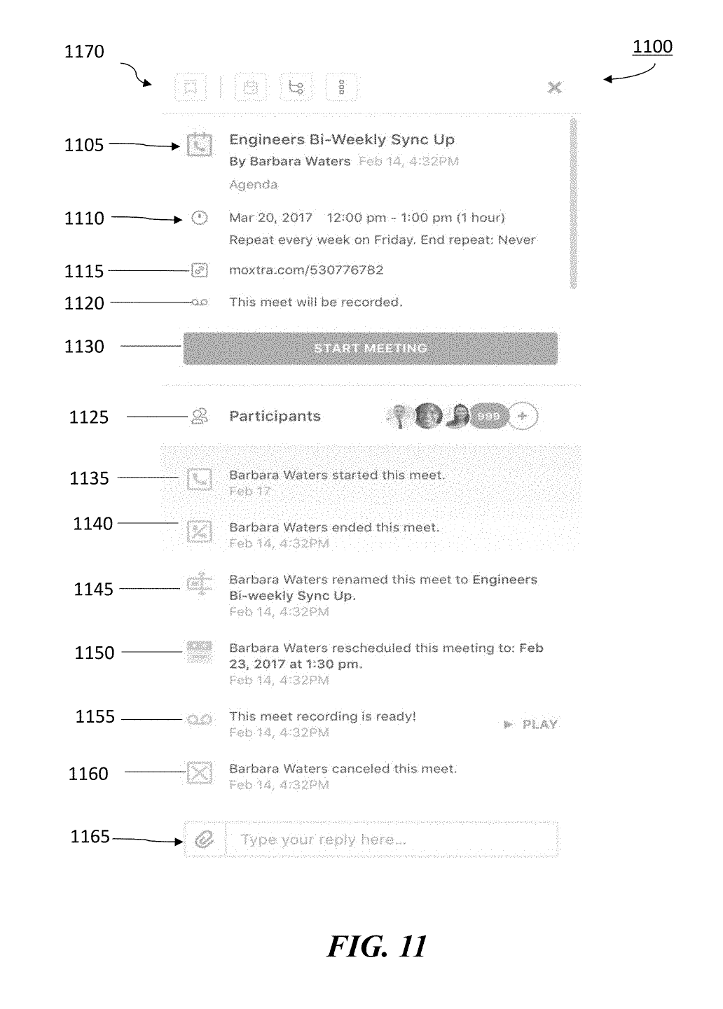

Turning now to FIG. 11, FIG. 11 is an example of a meeting object action (view), object action 1100, consistent with various embodiments. The thread object, which is being viewed thru meeting object action (view) 1100, may be similar to meeting object 1005 in FIG. 10. In meeting object action (view) 1100, users may view certain attributes of a meeting object, including: title, creator and creation date 1105; date, time, duration and repetition 1110; universal resource locator (URL) link to an online meeting 1115; recording notice 1120; and participants 1130, consistent with various embodiments. In meeting object action (view) 1100, users may also view a list of actions, notices and activity related to a meeting object, such as the following: meeting started 1135, meeting ended 1140, meeting renamed 1145, meeting rescheduled 1150, meeting recording available 1155 and meeting cancelled 1160, consistent with various embodiments. Users may also select actions while viewing a meeting object. For example, a user may reply to a previously-posted meeting object with a message object and/or a data file object by clicking an icon, such as the paper clip icon 1165. A user may request the meeting object action, start, be performed clicking the “START MEETING” app button 1130. As described above, in some embodiments, users may select a variety of object actions, such as bookmark and checklist object actions, associated with a thread object by clicking on icon 1170.

Returning back to FIG. 10, user 1040 requested performance of meeting object action (reschedule) associated with meeting object 1005, which was created by user 1010. Notifications of object actions taken by users, such as the cancellation 1035 of meeting object 1005, may be presented in message thread 1000, consistent with various embodiments. Notifications of user 1040 calling to join a meeting 1050, as well as icons, such as icon 1055, that allow users to join a meeting may be presented in a message thread. Message thread 1000 may display object action icons 1025, such as bookmark, comment and more object actions, associated with a meeting object, such as meeting object 1005.

### Message Thread Service

Turning now to FIG. 12, FIG. 12 is a block diagram, consistent with various embodiments, of an environment for managing message thread workflow using a thread object service, an object action service and a message thread service. Message thread workflow service 1235 of environment 1200 may be similar to message thread workflow service 125 of FIG. 1. Thread object service 1240 of environment 1200 may be similar to thread object service 135 of FIG. 1. Object action service 1245 of environment 1200 may be similar to object action service 135 of FIG. 1. Message thread service 1250 of environment 1200 may be similar to message thread service 140 of FIG. 1.

Consistent with various embodiments, message thread service 1250 stores and presents message threads, such as thread 1230, and tracking lists, such as tracking list 1255, to users, such as user 1205, user 1210 and user 1215. Message thread service 1250 presents message threads, which include thread objects with their associated object layers consisting of object actions and replies, such as thread objects 1220. Message thread service 1250 also presents individual, user tracking lists, such as tracking list 1255 to each user. A user's tracking list provides a list of that user's active thread objects. For example, tracking list 1255 may be a tracking list for user 1205. User 1205 may be mentioned in page comment object “Obj. 4” of message thread 1220, may have an assigned to-do in to-do object “Obj. 7” of message thread 1220, and may have created a bookmark associated with data file object “Obj. 2” of message thread 1220. In this example, “Obj. 4”, “Obj. 7” and “Obj. 2” of message thread 1220 would be the active thread objects of user 1205. Message thread service 1250 would present “Obj. 4”, “Obj. 7” and “Obj. 2” of message thread 1220 to user 1205 in tracking list 1255 for user 1205. A user may also be sent push notifications and/or other relevant alerts associated with the user's active thread objects. A user's tracking list may be presented as a side bar, along one side of that user's currently-viewed message thread, consistent with various embodiments.

Message threads, such as message thread 1230, and tracking lists, such as tracking list 1255, may be presented on a variety of devices, including a desktop, a laptop, a smart phone, or a tablet PC. Message threads and tracking lists may be presented using a web browser installed on the device. In some embodiments, the web browser may include a script for rendering a message thread 1230 and/or a user's tracking list 1255 on the device. In various embodiments, users, such as user 1205, user 1210 and user 1215, may be presented with more than one message thread 1230. Each user's tracking list, such as tracking list 1255, may include that user's active thread objects 1220 from more than one message thread, such as message thread 1230.

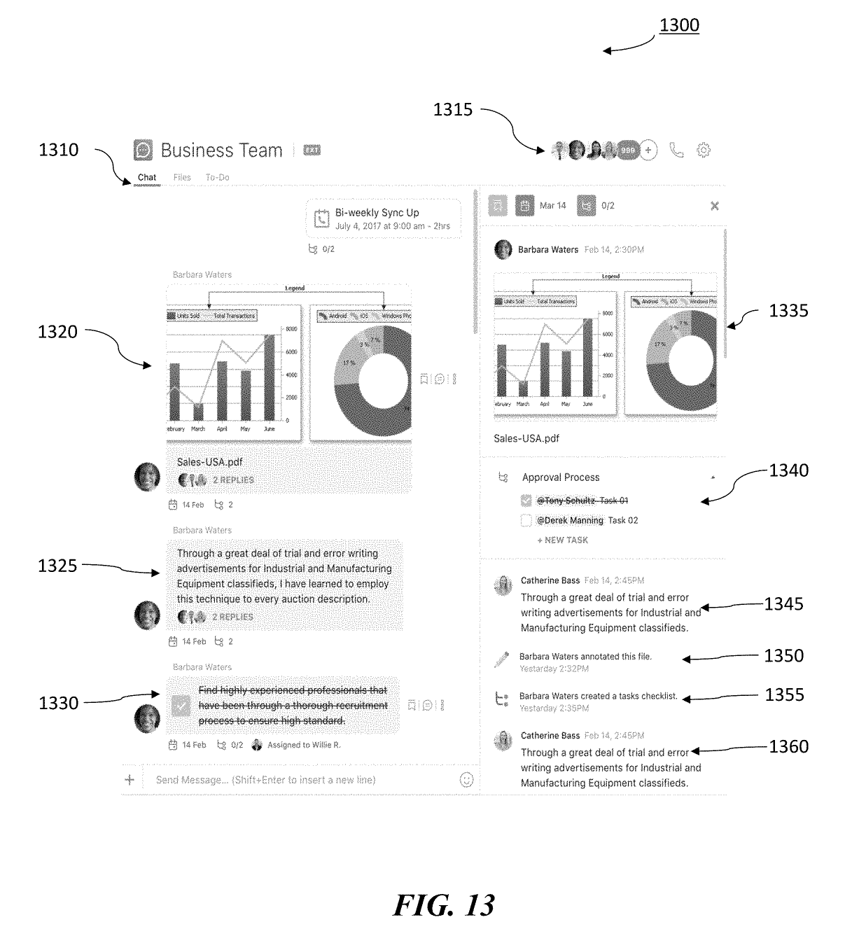

Turning now to FIG. 13, FIG. 13 is an example of a message thread presentation, presentation 1300, as presented to one of the users 1315, consistent with various embodiments. One of the users 1315 may be similar to one of the users 1205 1210 1215 of FIG. 12. Message thread 1310 may be similar to message thread 1230 of FIG. 12. Thread objects 1320 1325 1330 may be similar to thread objects 1220 of FIG. 12. In this example, message thread 1310 contains data file object, message object 1325, and to-do object 1330.

Presentation 1300 includes view 1335 of object layers 1340 1345 1350 1355 1360 associated with data file object 1320. Data file object 1320, as presented in 1335, may be similar to thread object 600 of FIG. 6. Object layers 1340 1345 1350 1355 1360 may be similar to the object layer 615 of FIG. 6. Data file object 1320 and its associated object layers 1340 1345 1350 1355 1360, as presented in 1335, may be similar to one of the thread objects 1220 in FIG. 12, specifically “Obj. 2”, and its associated object actions (“Act. 5 . . . ”) and replies. In this example, data file object 1320 is associated with checklist action 1340, message object 1345 reply, annotation action 1350, checklist action 1355 and message object 1360 reply. Actions 1340 1350 may be similar to actions 1225 of FIG. 12. Thread objects 1345 1360 may be similar to thread objects 1220 of FIG. 12.

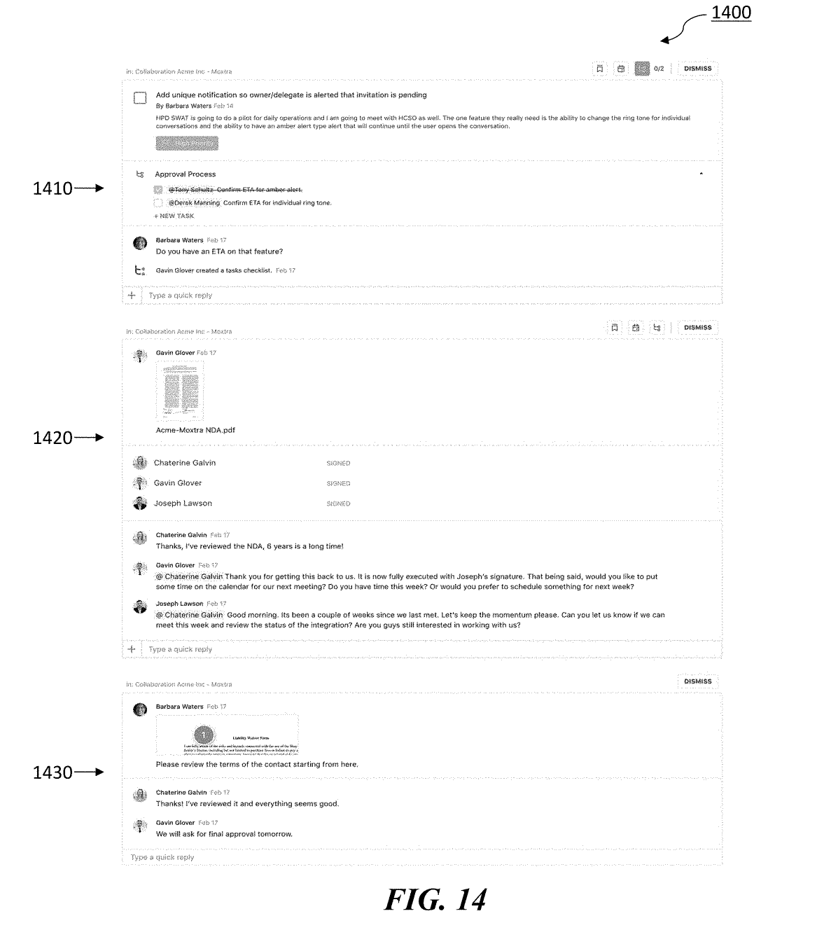

Turning now to FIG. 14, FIG. 14 is an example of a tracking list, tracking list 1400, as presented to a user, consistent with various embodiments. Tracking list 1400 may be similar to tracking list 1255 of FIG. 12. Tracking list 1400 consists of a user's active thread objects 1410 1420 1430. User's active thread objects 1410 1420 1430 may be similar to thread objects 1220 of FIG. 12. In this example, user's active thread objects include to-do object with its associated object layers 1410, document signature object with its associated object layers 1420, and page comment object with its associated object layers 1430.

### Example System for Message Thread Workflow

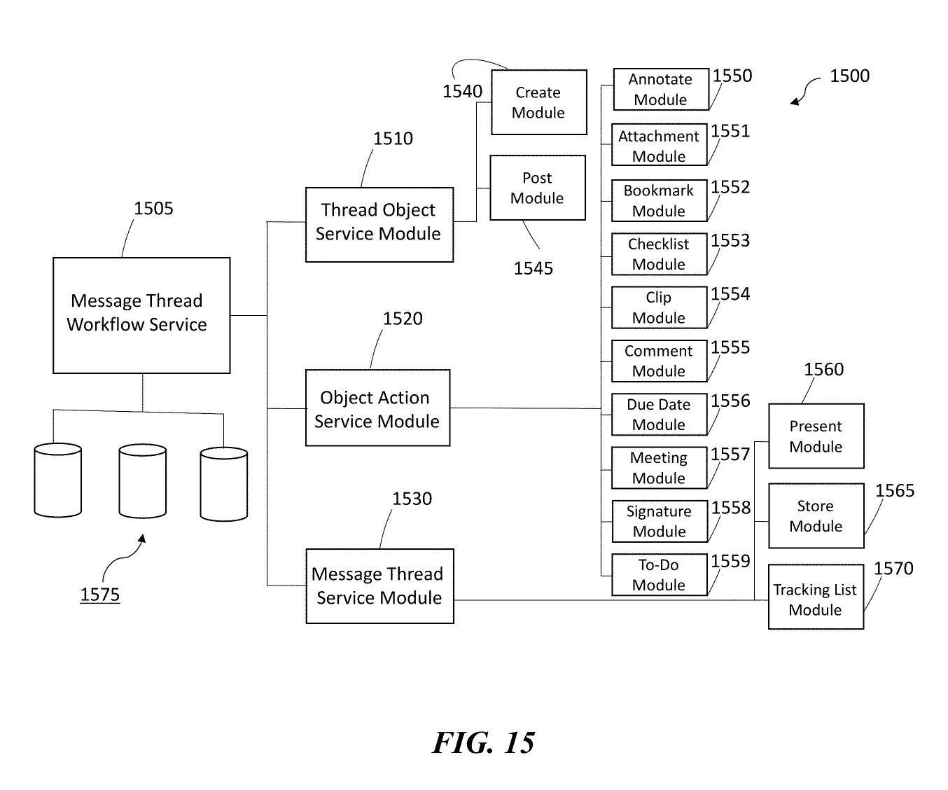

Turning now to FIG. 15, FIG. 15 is a block diagram of a system for a message thread workflow service of FIG. 1, consistent with various embodiments. In various embodiments, system 1500 is implemented to perform functions such as the functions of environment 100. In various embodiments, message thread workflow service 1505 may be similar to the message thread workflow service 125 of FIG. 1. Message thread workflow service 1505 includes various modules that provide services including creating and storing thread objects of multiple types, associating, performing and storing object actions of multiple types, presenting and storing message threads, and creating, presenting and storing tracking lists for individual users of the message workflow thread service.

Message thread workflow service 1505 includes thread object service module 1510, object action service module 1520 and message thread service module 1530. In various embodiments, thread object service module 1510 may be similar to thread object service 125. Thread object service module 1510 includes create module 1540 that facilitates the user to create thread objects of multiple types, including message objects, data file objects, document page objects, page comment objects, document signature objects, meeting objects, and to-do objects. Post module 1545 facilitates the user to post thread objects and object actions to message threads. Users may post a thread object of multiple types unassociated with other thread objects in a message thread, or associated as a reply to a previously-posted thread object in a message thread.

In various embodiments, object action service module 1520 may be similar to object action service 135 of FIG. 1. Object action service module 1520 includes modules to perform object actions of various types. Annotate module 1550 facilitates the user to create, edit and delete annotations associated with page objects. Attachment module 1551 facilitates the user to attach, detach and open data file attachments of multiple types associated with data file, document page, document signature, meeting, message and to-do objects. Bookmark module 1552 facilitates the user to bookmark and remove bookmarks associated with message, data file, document page, page comment and document signature objects. Checklist module 1553 facilitates the user to create, delete and view checklists (and subtasks for those checklists) associated with message, data file, document page, document signature and to-do objects. Checklist module 1553 further facilities the user to edit, delete, mark as complete, and view subtasks. Finally, checklist module 1553 facilitates saving checklists as templates, and selecting templates for checklist creation. Clip module 1554 facilitates the user to attach, delete and open audio and video clips associated with document page objects. Comment module 1555 facilitates the user to create, edit, delete and view comments associated with data file, document page, document signature, meeting and to-do objects. Due date module 1556 facilitates the user to delete, edit and view due dates associated with message, data file, document page, document signature and to-do objects. Meeting module 1557 facilitates the user to delete, edit, join, record, start and view meetings. Signature module 1558 facilitates the user to accept, decline and execute signatures of a document. To-do module 1559 facilitates the user to edit, delete and view to-dos.

In various embodiments, message thread service module 1530 may be similar to the message thread service 140 of FIG. 1. Message thread service module 1530 includes present module 1570 that presents messages threads to users. Message threads presented includes thread objects with their replies (associated thread objects) and their object actions. Further, the user may access the message threads from a device regardless of the operating system (or platform) of the device. The user may access the message threads using a web browser or the message thread workflow app installed on the device. Store module 1575 stores message threads, including thread objects with their replies (associated thread objects) and their object actions, in storage system 1575.

Tracking list module 1580, consistent with various embodiments, creates, manages, and presents tracking lists for each user. Tracking lists, which may be presented along-side a message thread, provide a list of the user's active threads objects. The user may access the tracking list from a device regardless of the operating system (or platform) of the device. The user may access the tracking list using a web browser or the message thread workflow app installed on the device. Tracking list module 1580 stores tracking lists in storage system 1575. In various embodiments, tracking list module 1580 sends push notifications and/or other relevant alerts associated with each user's active thread objects.

### Thread Objects

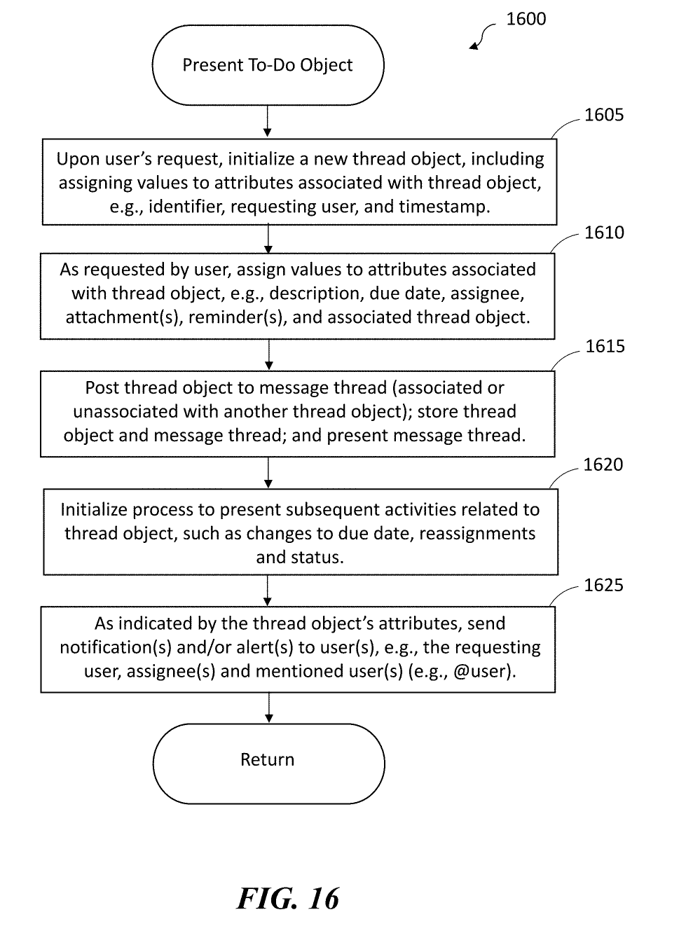

Turning now to FIG. 16, FIG. 16 is a flow diagram of a process of presenting a to-do object in a message thread, consistent with various embodiments. In some embodiments, process 1600 may be executed in a system such as system 1500 of FIG. 15. At block 1605, thread object service module 1510 receives a request from the user to create a new to-do object. Create module 1540 initializes a new to-do object, and assigns values to attributes of a to-do object, such as the thread object's identifier, request timestamp, requesting user and one or more mentioned users. At block 1610, create module 1540 receives input from the user in the form of values for attributes associated with the to-do object. In various embodiments, the to-do object attributes may include previously-posted thread object identifier, message (text or voice), description, due date, one or more assignees, reminder, one or more mentioned users, data file identifier, data file location and data file format. Data file formats may include, e.g., Microsoft Corporation's Word format, Microsoft Corporation's Excel® format, Microsoft Corporation's PowerPoint® format, Joint Photographic Experts Group (.jpg) format, Adobe Systems Incorporated's portable document (.pdf) format, Apple Inc.'s QuickTime® (.mov) format, Apple Inc.'s Keynote® format, graphics interchange (.gif) format, bitmap (.bmp) format, and Microsoft Corporation's text (.txt) format.

At block 1615, post module 1545 posts the to-do object to the message thread. Post module 1545 may post the to-do object unassociated with any other thread object in the message thread, consistent with various embodiments. Or, as indicated by the user, post module 1545 may post the to-do object associated as a reply to any previously-posted thread object in the message thread. Store module 1575 stores the to-do object and updated message thread. Present module 1570 presents the updated message thread to users.

At block 1620, message thread service module 1530 initiates a process whereby present module 1570 dynamically presents the subsequent activities related to the to-do object. In various embodiments, subsequent activities related to the to-do object may include changes to due date, reassignment to a different assignee, and updates to status (e.g., incomplete, complete, complete or past due). At block 1625, tracking list module 1580 sends notifications and/or alerts to, as indicated by the thread object's attributes, the requesting user, any assignees and any mentioned users (e.g., “@username”), consistent with various embodiments.

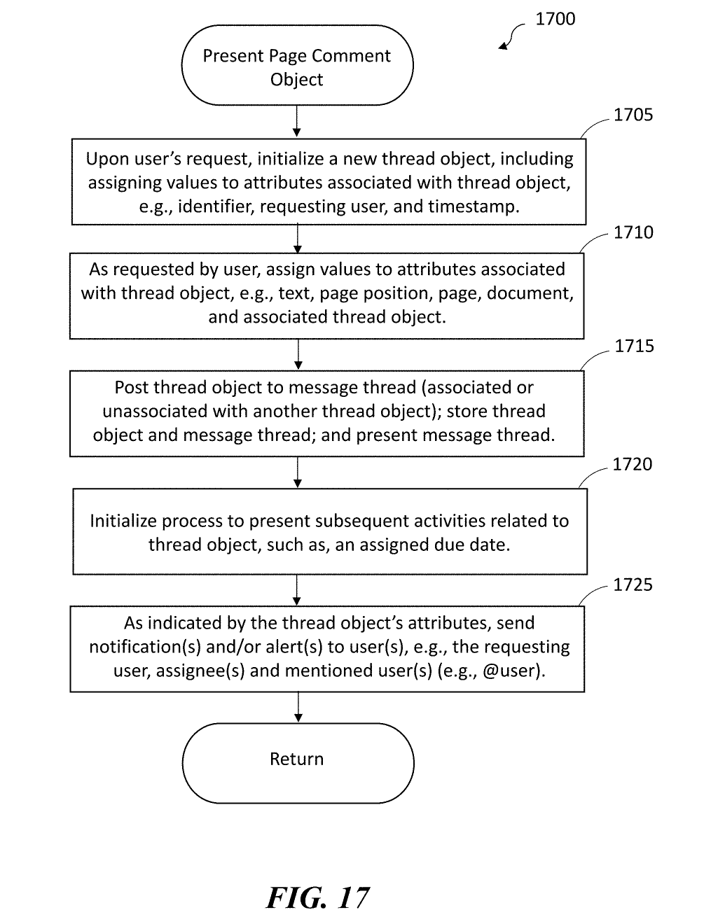

Turning now to FIG. 17, FIG. 17 is a flow diagram of a process of presenting a page comment object in a message thread, consistent with various embodiments. In some embodiments, process 1700 may be executed in a system such as system 1500 of FIG. 15. At block 1705, thread object service module 1510 receives a request from the user to create a new page comment object. Create module 1540 initializes a new page comment object, and assigns values to attributes of a page comment object, such as the thread object's identifier, request timestamp, requesting user and one or more mentioned users. At block 1710, create module 1540 receives input from the user in the form of values for attributes associated with the thread object. In various embodiments, the page comment object attributes may include previously-posted thread object identifier, message (text or voice), comment, page position, page number, document file identifier, document file location, and document file format. Document formats may include, e.g., Microsoft Corporation's Word format, Microsoft Corporation's Excel® format, Microsoft Corporation's PowerPoint® format, Adobe Systems Incorporated's portable document (.pdf) format, Apple Inc.'s Keynote® format, and Microsoft Corporation's text (.txt) format.

At block 1715, post module 1545 posts the page comment object to the message thread. Post module 1545 may post the page comment object unassociated with any other thread object in the message thread, consistent with various embodiments. Or, as indicated by the user, post module 1545 may post the page comment object associated as a reply to any previously-posted thread object in the message thread. Store module 1575 stores the page comment object and updated message thread. Present module 1570 presents the updated message thread to users.

At block 1720, message thread service module 1530 initiates a process whereby present module 1570 dynamically presents the subsequent activities related to the page comment object. In various embodiments, subsequent activities to the page comment object may include assigned due date, and/or the due date's related status (e.g., resolved). At block 1725, tracking list module 1580 sends notifications and/or alerts to, as indicated by the thread object's attributes, the requesting user, any assignees and any mentioned users (e.g., “@username”), consistent with various embodiments.

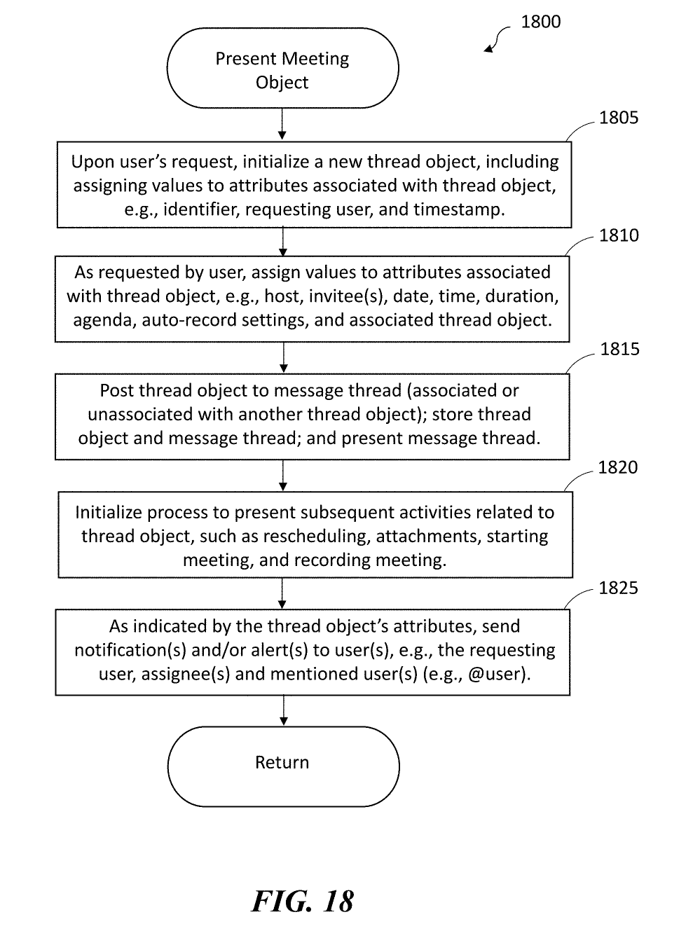

Turning now to FIG. 18, FIG. 18 is a flow diagram of a process of presenting a meeting object in a message thread, consistent with various embodiments. In some embodiments, process 1800 may be executed in a system such as system 1500 of FIG. 15. At block 1805, thread object service module 1510 receives a request from the user to create a new meeting object. Create module 1540 initializes a new meeting object, and assigns values to attributes of a meeting object, such as the thread object's identifier, request timestamp, requesting user and one or more mentioned users. At block 1810, create module 1540 receives input from the user in the form of values for attributes associated with the thread object. In various embodiments, the meeting object attributes may include host, one or more invitees, date, time, duration, agenda, auto-record settings, previously-posted thread object identifier, message (text or voice), document file identifier, document file location, and document file format. Document formats may include, e.g., Microsoft Corporation's Word format, Microsoft Corporation's Excel® format, Microsoft Corporation's PowerPoint® format, Adobe Systems Incorporated's portable document (.pdf) format, Apple Inc.'s Keynote® format, and Microsoft Corporation's text (.txt) format.

At block 1815, post module 1545 posts the meeting object to the message thread. Post module 1545 may post the meeting object independent of any other thread object in the message thread, consistent with various embodiments. Or, as indicated by the user, the post module 1545 may post the meeting object associated as a reply to any previously-posted thread object in the message thread. Store module 1575 stores the meeting object and updated message thread. Present module 1570 presents the updated message thread to users.

At block 1820, message thread service module 1530 initiates a process whereby present module 1570 dynamically presents the subsequent activities related to the meeting object. In various embodiments, subsequent activities to the meeting object may include rescheduling, attaching files, starting and recording. At block 1825, tracking list module 1580 sends notifications and/or alerts to, as indicated by the thread object's attributes, the requesting user, any invitees and any mentioned users (e.g., “@username”), consistent with various embodiments.

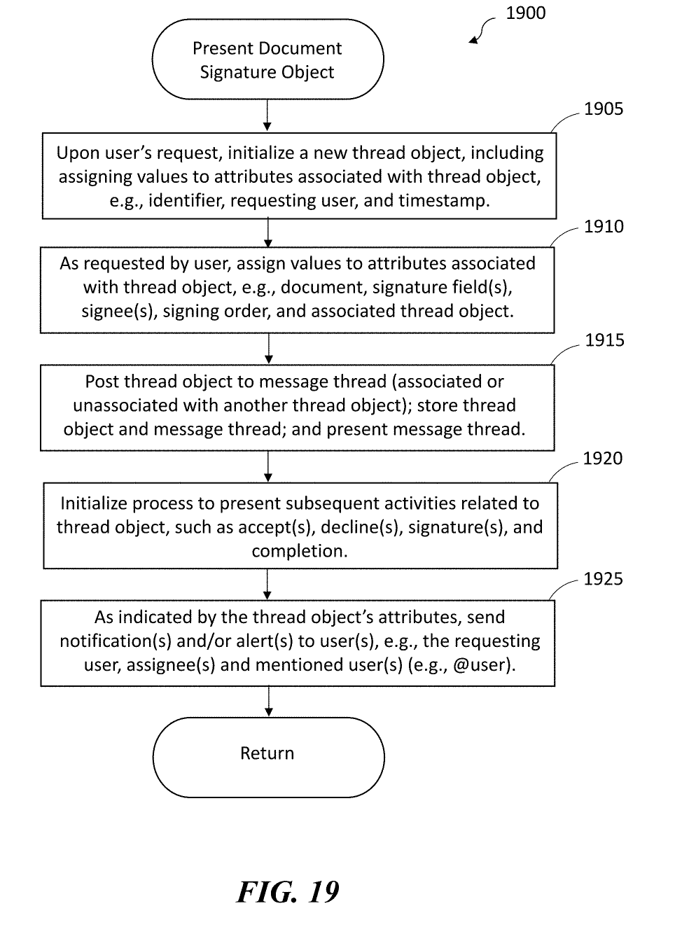

Turning now to FIG. 19, FIG. 19 is a flow diagram of a process of presenting a document signature object in a message thread, consistent with various embodiments. In some embodiments, process 1900 may be executed in a system such as system 1500 of FIG. 15. At block 1905, thread object service module 1510 receives a request from the user to create a document signature object. Create module 1540 initializes a new document signature object, and assigns values to attributes of a document signature object, such as the thread object's identifier, request timestamp, requesting user and one or more mentioned users. At block 1910, create module 1540 receives input from the user in the form of values for attributes associated with the thread object. In various embodiments, the document signature object attributes may include a previously-posted thread object identifier, message (text or voice), signature fields, one or more signees, one or more signing statuses, signing order, document status, due dates, bookmark locations, document file identifier, document file location, and document file format. Document formats may include, e.g., Microsoft Corporation's Word format, and Adobe Systems Incorporated's portable document (.pdf) format.

At block 1915, post module 1545 posts the document signature object to the message thread. Post module 1545 may post the document signature object unassociated with any other thread object in the message thread, consistent with various embodiments. Or, as indicated by the user, the post module 1545 may post the document signature object associated as a reply to any previously-posted thread object in the message thread. Store module 1575 stores the document signature object and updated message thread. Present module 1570 presents the updated message thread to users.

At block 1920, message thread service module 1530 initiates a process whereby present module 1570 dynamically presents the subsequent activities related to the document signature object. In various embodiments, subsequent activities to the document signature object may include the signers' acceptances, declinations and signatures, and the completion of the signature process. At block 1925, tracking list module 1580 sends notifications and/or alerts to, as indicated by the thread object's attributes, the requesting user, any signers and any mentioned users (e.g., “@username”), consistent with various embodiments.

Those skilled in the art will appreciate that the flow diagrams of a process of presenting other types of thread objects, such as message objects, data file objects and document page objects, in a message thread may be similar to the processes illustrated in FIGS. 16, 17, 18 and 19, consistent with various embodiments.

### Message Object

In some embodiments, thread object service module 1510 receives a request from the user to create a message object. Create module 1540 initializes a new message object, and assigns values to attributes of a message object, such as the thread object's identifier, request timestamp, requesting user and one or more mentioned users. Create module 1540 receives input from the user in the form of values for attributes associated with the thread object. In various embodiments, the message object attributes may include text data, voice data and previously-posted thread object identifier.

Post module 1545 posts the message object to the message thread either unassociated with any other thread object in the message thread, or (as indicated by the user), associated as a reply to any previously-posted thread object in the message thread, consistent with various embodiments. Store module 1575 stores the message object and updated message thread. Present module 1570 presents the updated message thread to users.

Message thread service module 1530 initiates a process whereby present module 1570 dynamically presents the subsequent activities related to the message object. In various embodiments, subsequent activities to the meeting object may include due dates. The tracking list module 1580 sends notifications and/or alerts to, as indicated by the thread object's attributes, the requesting user and any mentioned users (e.g., “@username”), consistent with various embodiments.

### Date File Object

In some embodiments, thread object service module 1510 receives a request from the user to create a data file object. Create module 1540 initializes a new data file object, and assigns values to attributes of a data file object, such as the thread object's identifier, request timestamp, requesting user and one or more mentioned users. Create module 1540 receives input from the user in the form of values for attributes associated with the thread object. In various embodiments, the data file object attributes may include previously-posted thread object identifier, message (text or voice), data file identifier, data file location and data file format. Data file formats may include, e.g., Microsoft Corporation's Word format, Microsoft Corporation's Excel® format, Microsoft Corporation's PowerPoint® format, Joint Photographic Experts Group (.jpg) format, Adobe Systems Incorporated's portable document (.pdf) format, Apple Inc.'s QuickTime® (.mov) format, Apple Inc.'s Keynote® format, graphics interchange (.gif) format, bitmap (.bmp) format, and Microsoft Corporation's text (.txt) format.

Post module 1545 posts the data file object to the message thread either unassociated with any other thread object in the message thread, or (as indicated by the user), associated as a reply to any previously-posted thread object in the message thread, consistent with various embodiments. Store module 1575 stores the data file object and updated message thread. Present module 1570 presents the updated message thread to users.

Message thread service module 1530 initiates a process whereby present module 1570 dynamically presents the subsequent activities related to the data file object. In various embodiments, subsequent activities to the data file object may include due dates. The tracking list module 1580 sends notifications and/or alerts to, as indicated by the thread object's attributes, the requesting user and any mentioned users (e.g., “@username”), consistent with various embodiments.

### Document Page Object

In some embodiments, thread object service module 1510 receives a request from the user to create a document page object. Create module 1540 initializes a new document page object, and assigns values to attributes of a document page object, such as thread object identifier, request timestamp, requesting user and one or more mentioned users. Create module 1540 receives input from the user in the form of values for attributes associated with the thread object. In various embodiments, the document page object attributes may include previously-posted thread object identifier, message (text or voice), one or more page numbers, document file identifier, document file location, and document file format. Document file formats may include, e.g., Microsoft Corporation's Word format, Microsoft Corporation's Excel® format, Microsoft Corporation's PowerPoint® format, Adobe Systems Incorporated's portable document (.pdf) format, Apple Inc.'s Keynote® format, and Microsoft Corporation's text (.txt) format.

Post module 1545 posts the document page object to the message thread either unassociated with any other thread object in the message thread, or (as indicated by the user), associated as a reply to any previously-posted thread object in the message thread, consistent with various embodiments. Store module 1575 stores the document page object and updated message thread. Present module 1570 presents the updated message thread to users.

Message thread service module 1530 initiates a process whereby present module 1570 dynamically presents the subsequent activities related to the document page object. In various embodiments, subsequent activities to the document page object may include due dates, annotations and comments. The tracking list module 1580 sends notifications and/or alerts to, as indicated by the thread object's attributes, the requesting user and any mentioned users (e.g., “@username”), consistent with various embodiments.

### Object Actions

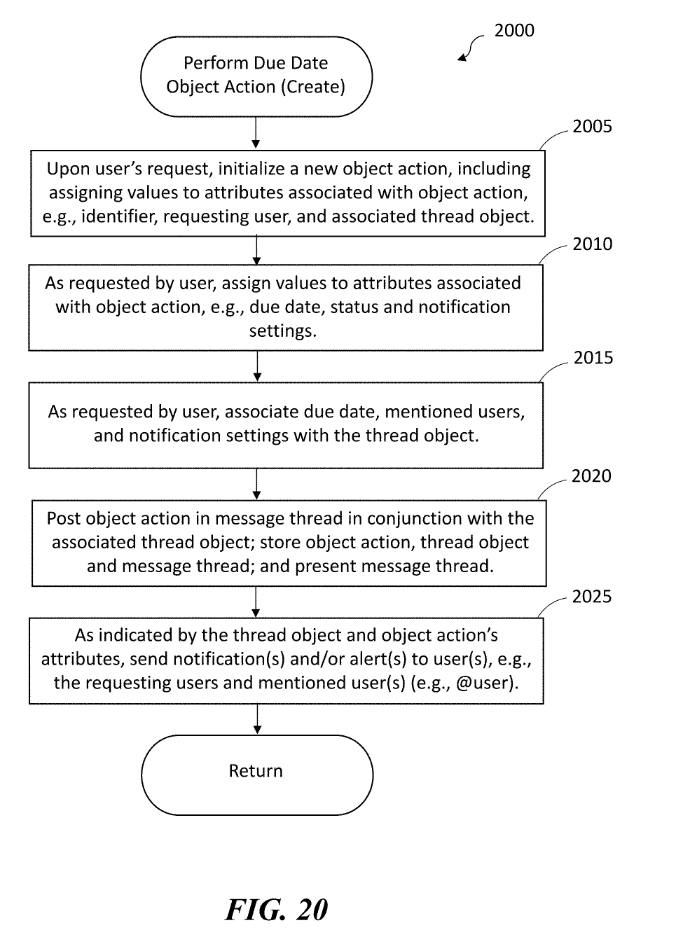

Turning now to FIG. 20, FIG. 20 is a flow diagram of a process of performing a due date object action with respect to any previously-posted thread object of any type in a message thread, consistent with various embodiments. Due date object actions may be one of the following types: create, delete, edit and view. In some embodiments, process 2000 may be executed in a system such as system 1500 of FIG. 15. At block 2005, object action service module 1520 receives a request from a user to perform one of the due date object actions, create. Object action service module 1520 initializes a new object action, and assigns values to attributes of an object action, such as the object action's identifier, request timestamp, requesting user, one or more mentioned users, and the previously-posted thread object identifier.

At block 2010, due date module 1556 receives input from the user in the form of values for attributes associated with the due date object action, create. In various embodiments, the due date object action attributes for create may include due date, message (text or voice), one or more notification settings (e.g., on, off, frequency, users), status (e.g., incomplete, complete, past due).

At block 2015, due date module 1556 associates the attributes due date, mentioned users, and one or more notification settings with the requested thread object.

At block 2020, post module 1545 posts the due date object action (create) in conjunction with the previously-posted thread object identifier to the message thread, consistent with various embodiments. Store module 1575 stores the due date object action (create), the previously-posted thread object identifier, and updated message thread. Present module 1570 presents the updated message thread to users.

At block 2025, tracking list module 1580 sends notifications and/or alerts to, as indicated by the object action's attributes and the previously-posted thread object identifier's attributes, the requesting users and any mentioned users (e.g., “@username”), consistent with various embodiments.

Those skilled in the art will appreciate that the flow diagrams of a process of performing other due date object actions, such as delete, edit and view, in a message thread may be similar to the process illustrated in FIG. 20, consistent with various embodiments. Object action service module 1520 receives a request from a user, and initializes a new object action. Due date module 1556 receives user input, and performs the requested object action. Post module 1545 posts the new date object action in conjunction with the previously-posted thread object identifier to the message thread. Store module 1575 stores the due date object action, the previously-posted thread object identifier, and updated message thread. Present module 1570 presents the updated message thread to users. Tracking list module 1580 sends notifications and/or alerts to, as indicated by the object action's attributes and the previously-posted thread object identifier's attribute.

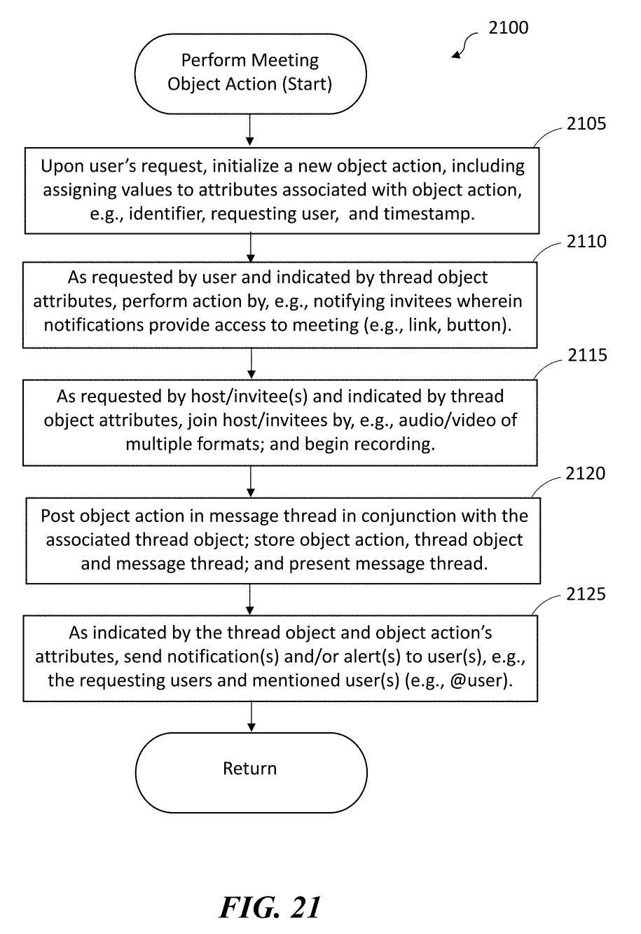

Turning now to FIG. 21, FIG. 21 is a flow diagram of a process of performing a meeting object action with respect to any previously-posted message object in a message thread, consistent with various embodiments. Meeting object actions include the following types: delete, edit (e.g., date, description, invitees and time), join, record, start and view. In some embodiments, process 2100 may be executed in a system such as system 1500 of FIG. 15. At block 2105, object action service module 1520 receives a request from a user to perform one of the meeting object actions, start. Object action service module 1520 initializes a new object action, and assigns values to attributes of an object action, such as the object action's identifier, request timestamp, requesting user, one or more mentioned users, and the previously-posted thread object identifier.

At block 2110, as requested by user and as indicated in the associated meeting object, meeting module 1557 notifies the one or more invitees that the meeting is starting. In those notifications, meeting module 1557 provides invitees modes of access to the meeting. Modes may be of various types, e.g., a URL link, an app button, a phone number or a meeting id, consistent with various embodiment.

At block 2115, as requested by the host and invitees and as indicated in the associated meeting object, meeting module 1557 connects the host and invitees to the meeting. Connection to the meeting may be of various types, e.g., audio and/video. Meeting module 1557 records the meeting, as indicated by the relevant attributes.

At block 2120, post module 1545 posts the meeting object action (start) in conjunction with the previously-posted thread object identifier to the message thread, consistent with various embodiments. Store module 1575 stores the meeting object action (start), the previously-posted thread object identifier, and updated message thread. Present module 1570 presents the updated message thread to users.

At block 2125, tracking list module 1580 sends notifications and/or alerts to, as indicated by the object action's attributes and the previously-posted thread object identifier's attributes, the requesting users and any mentioned users (e.g., “@username”), consistent with various embodiments.

Those skilled in the art will appreciate that the flow diagrams of a process of performing other meeting object actions, such as delete, edit, join, record and view, in a message thread may be similar to the process illustrated in FIG. 21, consistent with various embodiments. Object action service module 1520 receives a request from a user, and initializes a new object action. Due date module 1556 receives user input, and performs the requested object action. Post module 1545 posts the new date object action in conjunction with the previously-posted thread object identifier to the message thread. Store module 1575 stores the due date object action, the previously-posted thread object identifier, and updated message thread. Present module 1570 presents the updated message thread to users. Tracking list module 1580 sends notifications and/or alerts to, as indicated by the object action's attributes and the previously-posted thread object identifier's attribute.

### Annotate Object Action

Those skilled in the art will appreciate that the flow diagrams of a process of performing annotate object actions in a message thread may be similar to the processes illustrated in FIGS. 20 and 21, consistent with various embodiments. Annotate object actions may include the following types: create, delete, edit and view. Object action service module 1520 receives a request from a user to perform one of the annotate object actions (e.g., create) associated with any previously-posted document page object. Object action service module 1520 initializes a new object action, and assigns values to attributes of an object action, such as the object action's identifier, request timestamp, requesting user, one or more mentioned users, and the previously-posted thread object identifier.

Annotate module 1550 receives input from the user in the form of values for attributes associated with the annotate object action, e.g., create. In various embodiments, the annotate object action attributes for create may include document file identifier, document file location, page, page position, annotation type (e.g., predefined symbol (e.g., line, arrow, circle) and free-hand mark (e.g., pencil, highlighter)), and annotation.

Annotate module 1550 associates the object action attributes document file identifier, document file location, page, page position, annotation type and annotation with the requested thread object.

Post module 1545 posts the annotate object action (create) in conjunction with the previously-posted thread object identifier to the message thread, consistent with various embodiments. Store module 1575 stores the annotate object action (create), the previously-posted thread object identifier, and updated message thread. Present module 1570 presents the updated message thread to users.

Tracking list module 1580 sends notifications and/or alerts to, as indicated by the object action's attributes and the previously-posted thread object identifier's attributes, the requesting users and any mentioned users (e.g., “@username”), consistent with various embodiments.

Those skilled in the art will appreciate that the flow diagrams of a process of performing other annotate object actions, such as delete, edit and view, in a message thread may be similar to the process illustrated in FIGS. 20 and 21, consistent with various embodiments. Object action service module 1520 receives a request from a user, and initializes a new object action. Annotate module 1550 receives user input, and performs the requested object action. Post module 1545 posts the new annotate object action in conjunction with the previously-posted thread object identifier to the message thread. Store module 1575 stores the annotate object action, the previously-posted thread object identifier, and updated message thread. Present module 1570 presents the updated message thread to users. Tracking list module 1580 sends notifications and/or alerts to, as indicated by the object action's attributes and the previously-posted thread object identifier's attribute.

### Attachment Object Action

Those skilled in the art will appreciate that the flow diagrams of a process of performing attachment object actions in a message thread may be similar to the processes illustrated in FIGS. 20 and 21, consistent with various embodiments. Attachment object actions may include the following types: attach, detach and open. Object action service module 1520 receives a request from a user to perform one of the attachment object actions (e.g., attach) associated with any previously-posted data file, document page, document signature, meeting, message or to-do object. Object action service module 1520 initializes a new object action, and assigns values to attributes of an object action, such as the object action's identifier, request timestamp, requesting user, one or more mentioned users, and the previously-posted thread object identifier.

Attachment module 1551 receives input from the user in the form of values for attributes associated with the attachment object action, attach. In various embodiments, the attachment object action attributes for attach may include data file identifier, data file location and data file format. Data files of multiple formats can be attached to (associated with) a thread object, including, e.g., Microsoft Corporation's Word format, Microsoft Corporation's Excel® format, Microsoft Corporation's PowerPoint® format, Joint Photographic Experts Group (.jpg) format, Adobe Systems Incorporated's portable document (.pdf) format, Apple Inc.'s QuickTime® (.mov) format, Apple Inc.'s Keynote® format, graphics interchange (.gif) format, bitmap (.bpm) format, and Microsoft Corporation's text (.txt) format.

Attachment module 1551 associates the object action attributes data file identifier, data file location and data file format with the requested thread object.

Post module 1545 posts the attachment object action (attach) in conjunction with the previously-posted thread object identifier to the message thread, consistent with various embodiments. Store module 1575 stores the attachment object action (attach), the previously-posted thread object identifier, and updated message thread. Present module 1570 presents the updated message thread to users.

Tracking list module 1580 sends notifications and/or alerts to, as indicated by the object action's attributes and the previously-posted thread object identifier's attributes, the requesting users and any mentioned users (e.g., “@username”), consistent with various embodiments.

Those skilled in the art will appreciate that the flow diagrams of a process of performing other attachment object actions, such as detach and open, in a message thread may be similar to the process illustrated in FIGS. 20 and 21, consistent with various embodiments. Object action service module 1520 receives a request from a user, and initializes a new object action. Attachment module 1551 receives user input, and performs the requested object action. Post module 1545 posts the new attachment object action in conjunction with the previously-posted thread object identifier to the message thread. Store module 1575 stores the attachment object action, the previously-posted thread object identifier, and updated message thread. Present module 1570 presents the updated message thread to users. Tracking list module 1580 sends notifications and/or alerts to, as indicated by the object action's attributes and the previously-posted thread object identifier's attribute.

### Bookmark Object Action

Those skilled in the art will appreciate that the flow diagrams of a process of performing bookmark object actions in a message thread may be similar to the processes illustrated in FIGS. 20 and 21, consistent with various embodiments. Bookmark object actions may include the following types: bookmark and remove bookmark. Object action service module 1520 receives a request from a user to perform one of the bookmark object actions (e.g., bookmark) associated with any previously-posted data file, document page, document signature or message object. Object action service module 1520 initializes a new object action, and assigns values to attributes of an object action, such as the object action's identifier, request timestamp, requesting user, one or more mentioned users, and the previously-posted thread object identifier.

Bookmark module 1552 receives input from the user in the form of values for attributes associated with the bookmark object action, bookmark. In various embodiments, the bookmark object action attributes for attach may include bookmark location.

Bookmark module 1552 associates the object action attribute bookmark location with the requested thread object.

Post module 1545 posts the bookmark object action (bookmark) in conjunction with the previously-posted thread object identifier to the message thread, consistent with various embodiments. Store module 1575 stores the bookmark object action (bookmark), the previously-posted thread object identifier, and updated message thread. Present module 1570 presents the updated message thread to users.

Tracking list module 1580 sends notifications and/or alerts to, as indicated by the object action's attributes and the previously-posted thread object identifier's attributes, the requesting users and any mentioned users (e.g., “@username”), consistent with various embodiments.

Those skilled in the art will appreciate that the flow diagrams of a process of performing other bookmark object actions, such as remove bookmark, in a message thread may be similar to the process illustrated in FIGS. 20 and 21, consistent with various embodiments. Object action service module 1520 receives a request from a user, and initializes a new object action. Bookmark module 1552 receives user input, and performs the requested object action. Post module 1545 posts the new bookmark object action in conjunction with the previously-posted thread object identifier to the message thread. Store module 1575 stores the bookmark object action, the previously-posted thread object identifier, and updated message thread. Present module 1570 presents the updated message thread to users. Tracking list module 1580 sends notifications and/or alerts to, as indicated by the object action's attributes and the previously-posted thread object identifier's attribute.

### Checklist Object Action

Those skilled in the art will appreciate that the flow diagrams of a process of performing checklist object actions in a message thread may be similar to the processes illustrated in FIGS. 20 and 21, consistent with various embodiments. Checklist object actions may include the following types: create, create from template, delete, edit, save as template, and view. Object action service module 1520 receives a request from a user to perform one of the checklist object actions (e.g., create) associated with any previously-posted data file, document page, document signature, message or to-do object. Object action service module 1520 initializes a new object action, and assigns values to attributes of an object action, such as the object action's identifier, request timestamp, requesting user, one or more mentioned users, and the previously-posted thread object identifier.

Checklist module 1553 receives input from the user in the form of values for attributes associated with the checklist object action, create. In various embodiments, the checklist object action attributes for create may include checklist title, one or more subtask descriptions, and one or more subtasks' status.

Checklist module 1553 associates the object action's attributes checklist title, subtask description(s), and subtask status(es) with the requested thread object.

Post module 1545 posts the checklist object action (create) in conjunction with the previously-posted thread object identifier to the message thread, consistent with various embodiments. Store module 1575 stores the checklist object action (create), the previously-posted thread object identifier, and updated message thread. Present module 1570 presents the updated message thread to users.

Tracking list module 1580 sends notifications and/or alerts to, as indicated by the object action's attributes and the previously-posted thread object identifier's attributes, the requesting users and any mentioned users (e.g., “@username”), consistent with various embodiments.

Those skilled in the art will appreciate that the flow diagrams of a process of performing other checklist object actions, such as create, create from template, delete, edit, save as template and view, in a message thread may be similar to the process illustrated in FIGS. 20 and 21, consistent with various embodiments. Object action service module 1520 receives a request from a user, and initializes a new object action. Checklist module 1553 receives user input, and performs the requested object action. Post module 1545 posts the new checklist object action in conjunction with the previously-posted thread object identifier to the message thread. Store module 1575 stores the checklist object action, the previously-posted thread object identifier, and updated message thread. Present module 1570 presents the updated message thread to users. Tracking list module 1580 sends notifications and/or alerts to, as indicated by the object action's attributes and the previously-posted thread object identifier's attribute.

### Clip Object Action

Those skilled in the art will appreciate that the flow diagrams of a process of performing clip object actions in a message thread may be similar to the processes illustrated in FIGS. 20 and 21, consistent with various embodiments. Clip object actions may include the following types: attach, detach and open. Object action service module 1520 receives a request from a user to perform one of the clip object actions (e.g., attach) associated with any previously-posted document page object. Object action service module 1520 initializes a new object action, and assigns values to attributes of an object action, such as the object action's identifier, request timestamp, requesting user, one or more mentioned users, and the previously-posted thread object identifier.

Clip module 1554 receives input from the user in the form of values for attributes associated with the clip object action, attach. In various embodiments, the clip object action attributes for attach may include audio or video data file identifier, audio or video data file location, and audio or video data file format. Audio and video data files may be of multiple formats.

Clip module 1554 associates the object action's attributes audio or video data file identifier, audio or video data file location and audio or video data file format with the requested thread object.

Post module 1545 posts the clip object action (attach) in conjunction with the previously-posted thread object identifier to the message thread, consistent with various embodiments. Store module 1575 stores the clip object action (attach), the previously-posted thread object identifier, and updated message thread. Present module 1570 presents the updated message thread to users.

Tracking list module 1580 sends notifications and/or alerts to, as indicated by the object action's attributes and the previously-posted thread object identifier's attributes, the requesting users and any mentioned users (e.g., “@username”), consistent with various embodiments.

Those skilled in the art will appreciate that the flow diagrams of a process of performing other clip object actions, such as detach and open, in a message thread may be similar to the process illustrated in FIGS. 20 and 21, consistent with various embodiments. Object action service module 1520 receives a request from a user, and initializes a new object action. Clip module 1554 receives user input, and performs the requested object action. Post module 1545 posts the new clip object action in conjunction with the previously-posted thread object identifier to the message thread. Store module 1575 stores the clip object action, the previously-posted thread object identifier, and updated message thread. Present module 1570 presents the updated message thread to users. Tracking list module 1580 sends notifications and/or alerts to, as indicated by the object action's attributes and the previously-posted thread object identifier's attribute.

### Comment Object Action

Those skilled in the art will appreciate that the flow diagrams of a process of performing comment object actions in a message thread may be similar to the processes illustrated in FIGS. 20 and 21, consistent with various embodiments. Comment object actions may include the following types: create, delete, edit and view. Object action service module 1520 receives a request from a user to perform one of the comment object actions (e.g., create) associated with any previously-posted data file, document page, page comment, document signature, meeting or to-do object. Data file and document objects may be of multiple formats. Object action service module 1520 initializes a new object action, and assigns values to attributes of an object action, such as the object action's identifier, request timestamp, requesting user, one or more mentioned users, and the previously-posted thread object identifier.

Comment module 1555 receives input from the user in the form of values for attributes associated with the comment object action, create. In various embodiments, the comment object action attributes for create may include text data.

Comment module 1555 associates the object action's attribute comment with the requested thread object.

Post module 1545 posts the comment object action (create) in conjunction with the previously-posted thread object identifier to the message thread, consistent with various embodiments. Store module 1575 stores the comment object action (create), the previously-posted thread object identifier, and updated message thread. Present module 1570 presents the updated message thread to users.

Tracking list module 1580 sends notifications and/or alerts to, as indicated by the object action's attributes and the previously-posted thread object identifier's attributes, the requesting users and any mentioned users (e.g., “@username”), consistent with various embodiments.

Those skilled in the art will appreciate that the flow diagrams of a process of performing other comment object actions, such as delete, edit and view, in a message thread may be similar to the process illustrated in FIGS. 20 and 21, consistent with various embodiments. Object action service module 1520 receives a request from a user, and initializes a new object action. Comment module 1555 receives user input, and performs the requested object action. Post module 1545 posts the new comment object action in conjunction with the previously-posted thread object identifier to the message thread. Store module 1575 stores the comment object action, the previously-posted thread object identifier, and updated message thread. Present module 1570 presents the updated message thread to users. Tracking list module 1580 sends notifications and/or alerts to, as indicated by the object action's attributes and the previously-posted thread object identifier's attribute.

### Signature Object Action

Those skilled in the art will appreciate that the flow diagrams of a process of performing signature object actions in a message thread may be similar to the processes illustrated in FIGS. 20 and 21, consistent with various embodiments. Signature object actions may include the following types: accept, decline and execute. Object action service module 1520 receives a request from a user to perform one of the signature object actions (e.g., execute) associated with any previously-posted document signature object. Object action service module 1520 initializes a new object action, and assigns values to attributes of an object action, such as the object action's identifier, request timestamp, requesting user, one or more mentioned users, and the previously-posted thread object identifier.

Signature module 1558 receives input from the user in the form of values for attributes associated with the signature object action, execute. In various embodiments, the signature object action attributes for execute may include one of one or more signers and one of one or more signer responses.

Signature module 1558 associates the object action's attributes signer and signer response with the requested thread object.

Post module 1545 posts the signature object action (execute) in conjunction with the previously-posted thread object identifier to the message thread, consistent with various embodiments. Store module 1575 stores the signature object action (execute), the previously-posted thread object identifier, and updated message thread. Present module 1570 presents the updated message thread to users.

Tracking list module 1580 sends notifications and/or alerts to, as indicated by the object action's attributes and the previously-posted thread object identifier's attributes, the requesting users and any mentioned users (e.g., “@username”), consistent with various embodiments.

Those skilled in the art will appreciate that the flow diagrams of a process of performing other signature object actions, such as accept and decline, in a message thread may be similar to the process illustrated in FIGS. 20 and 21, consistent with various embodiments. Object action service module 1520 receives a request from a user, and initializes a new object action. Signature module 1558 receives user input, and performs the requested object action. Post module 1545 posts the new signature object action in conjunction with the previously-posted thread object identifier to the message thread. Store module 1575 stores the signature object action, the previously-posted thread object identifier, and updated message thread. Present module 1570 presents the updated message thread to users. Tracking list module 1580 sends notifications and/or alerts to, as indicated by the object action's attributes and the previously-posted thread object identifier's attribute.

### To-Do Object Action

Those skilled in the art will appreciate that the flow diagrams of a process of performing to-do object actions in a message thread may be similar to the processes illustrated in FIGS. 20 and 21, consistent with various embodiments. To-do object actions may include the following types: delete, edit (e.g., assignment, description, due date, notifications, priority and status) and view. Object action service module 1520 receives a request from a user to perform one of the to-do object actions (e.g., edit (due date)) associated with any previously-posted to-do object. Object action service module 1520 initializes a new object action, and assigns values to attributes of an object action, such as the object action's identifier, request timestamp, requesting user, one or more mentioned users, and the previously-posted thread object identifier.

To-do module 1559 receives input from the user in the form of values for attributes associated with the to-do object action, edit (due date). In various embodiments, the to-do object action attributes for execute may include attribute (due date) and attribute value (new due date).

To-do module 1559 associates the object action's attributes attribute (due date) and attribute value (new due date) with the requested thread object.

Post module 1545 posts the to-do object action (edit (due date)) in conjunction with the previously-posted thread object identifier to the message thread, consistent with various embodiments. Store module 1575 stores the to-do object action (edit (due date)), the previously-posted thread object identifier, and updated message thread. Present module 1570 presents the updated message thread to users.

Tracking list module 1580 sends notifications and/or alerts to, as indicated by the object action's attributes and the previously-posted thread object identifier's attributes, the requesting users and any mentioned users (e.g., “@username”), consistent with various embodiments.

Those skilled in the art will appreciate that the flow diagrams of a process of performing other to-do object actions, such as delete and view, in a message thread may be similar to the process illustrated in FIGS. 20 and 21, consistent with various embodiments. Object action service module 1520 receives a request from a user, and initializes a new object action. To-do module 1559 receives user input, and performs the requested object action. Post module 1545 posts the new to-do object action in conjunction with the previously-posted thread object identifier to the message thread. Store module 1575 stores the to-do object action, the previously-posted thread object identifier, and updated message thread. Present module 1570 presents the updated message thread to users. Tracking list module 1580 sends notifications and/or alerts to, as indicated by the object action's attributes and the previously-posted thread object identifier's attribute.

### Tracking Lists

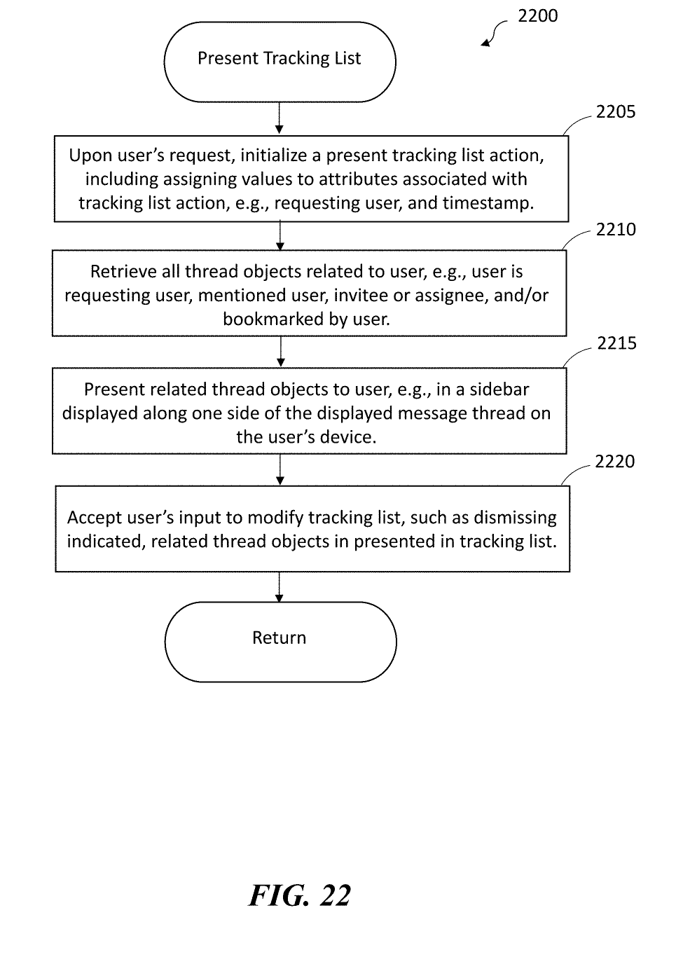

Turning now to FIG. 22, FIG. 22 is a flow diagram of a process of presenting a tracking list with respect to the user, consistent with various embodiments. In some embodiments, process 2200 may be executed in a system such as system 1500 of FIG. 15. At block 2205, message thread service module 1530 receives a request from the user, initializes a present tracking list action, including assigning values to attributes associated with a present tracking list action, such as, the tracking list request's identifier, request timestamp, requesting user and message thread identifier(s).

At block 2210, tracking list module 1570 retrieves all thread objects and object actions related to the user in the indicated message thread(s). In various embodiments, thread objects and object actions are related to the user wherein the user is, e.g., a requesting user, a mentioned user or an invitee. At block 2215, tracking list module 1570 presents the related thread objects in the user's tracking list. The user's tracking list is presented to the user on the user's device. In some embodiments, the tracking list is presented in a sidebar displayed along one side of a displayed message thread on the user's device.

At block 2215, tracking list module 1570 initiates a process to dynamically accept the user's input regarding modifying the display of the tracking list, consistent with various embodiments. For example, the user may dismiss one of the active thread objects displayed in the tracking list by clicking on an ‘x’ icon associated with that object.

### Example Computer System

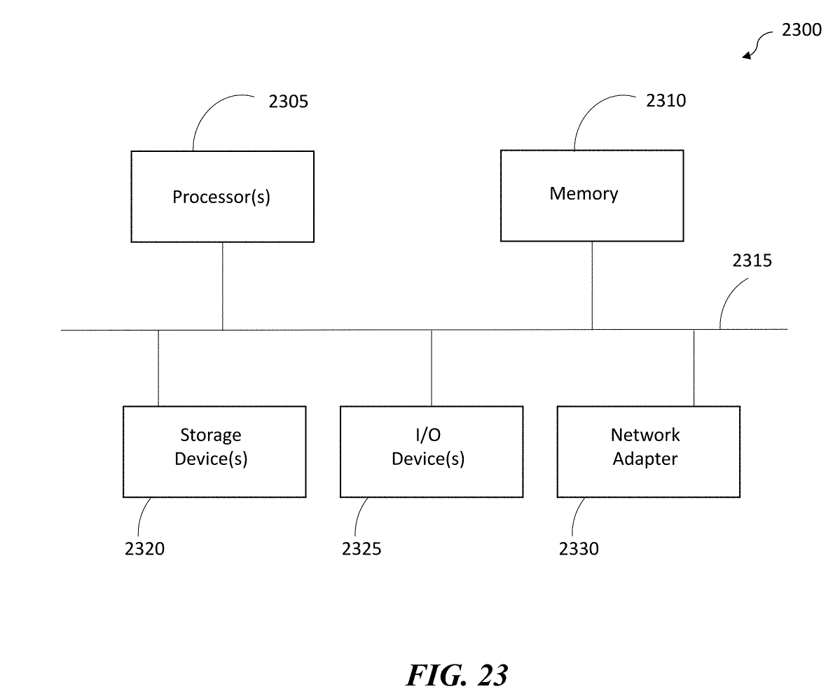

Turning now to FIG. 23, FIG. 23 is a block diagram of a computer system as may be used to implement features of some embodiments of the disclosed technology. Computing system 2300 may include one or more central processing units (“processors”) 2305, memory 2310, input/output devices 2315 (e.g., key-board and pointing devices, display devices), storage devices 2320 (e.g., disk drives), and network adapters 2330 (e.g., network interfaces) that are connected to an interconnect 2315. The interconnect 2315 is illustrated as an abstraction that represents any one or more separate physical buses, point to point connections, or both connected by appropriate bridges, adapters, or controllers. The interconnect 2315, therefore, may include, for example, a system bus, a Peripheral Component Interconnect (PCI) bus or PCI-Express bus, a Hyper Transport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 2310 and storage devices 2320 are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media may include computer-readable media (e.g., “non-transitory” media) and computer-readable transmission media. The instructions stored in memory 2310 may be implemented as software and/or firmware to program the processor(s) 2305 to carry out actions described above. In some embodiments, such software or firmware may be initially provided to the processing system 2300 by downloading it from a remote system through the computing system 2300 (e.g., via network adapter 2330).

The technology introduced herein may be implemented by, for example, programmable circuitry (e.g., one or more microprocessors) programmed with software and/or firmware, or entirely in special-purpose hardwired (non-program-mable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the invention. Accordingly, the invention is not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure in this specification are used to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing may be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Those skilled in the art will appreciate that the logic illustrated in each of the flow diagrams discussed above, may be altered in various ways. For example, the order of the logic may be rearranged, sub-steps may be performed in parallel, illustrated logic may be omitted, other logic may be included, etc.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Furthermore, in the specification, figures and claims, reference is made to particular features (including method steps) of the invention. It is to be understood that the disclosure of the invention includes all possible combinations of such particular features. For example, where a particular feature is disclosed in the context of a particular aspect or embodiment of the invention, or a particular claim, that feature may also be used, to the extent possible, in combination with and/or in the context of other particular aspects and embodiments of the invention.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an article “comprising” (or “which comprises”) components A, B and C may consist of (i.e., contain only) components A, B and C, or may contain not only components A, B, and C but also contain one or more other components.

Where reference is made herein to a method comprising two or more defined steps, the defined steps may be carried out in any order or simultaneously (except where the context excludes that possibility), and the method may include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

Aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” “program,” “device,” or “system.” Furthermore, aspects of the disclosed invention may take the form of a computer program product embodied in one or more computer readable media having computer readable program code embodied thereon.

Any element in a claim that does not explicitly state “means for” performing a specified function, or “step for” performing a specific function is not to be interpreted as a “means” or “step” clause as specified in 35. U.S.C. § 112 ¶6. Specifically, the use of “step of” in the claims herein is not intended to invoke the provisions of U.S.C. § 112 ¶6.

We claim:

1. A method comprising:
receiving, by a message thread workflow service executing on a computer system, a request from a user of one or more users with respect to at least one of a message thread of one or more message threads and a thread object, the thread object being either a new thread object or a previously-posted thread object of one or more previously-posted thread objects in the message thread, and the request being one of create thread object, perform object action, post thread object, post object action, present message thread or present tracking list;
executing, by the message thread workflow service, the request by:
(a) creating the new thread object, the new thread object being one of the following types:
(i) data file object,
(ii) document page object,
(iii) document signature object,
(iv) meeting object,
(v) message object,
(vi) page comment object or
(vii) to-do list object;
(b) performing an object action associated with the previously-posted thread object, the object action being one of the following types:
(i) annotate object action,
(ii) attachment object action,
(iii) bookmark object action,
(iv) checklist object action,
(v) clip object action,
(vi) comment object action,
(vii) due date object action,
(viii) meeting object action,
(ix) signature object action or
(x) to-do object action;
(c) posting the new thread object to the message thread either: (i) unassociated with any previously-posted thread object in the message thread, or (ii) associated as a reply with a previously-posted thread object of one or more previously-posted thread objects in the message thread;
(d) posting an object action associated with the previously-posted thread object to the message thread;
(e) presenting the message thread to the user, the message thread including one or more thread objects presented in conjunction with any associated replies and object actions; or
(f) presenting a tracking list to the user, the tracking list including any thread objects associated with the user in the message thread; and
storing, at the message thread workflow service, the message thread and at least one of the new thread object, the previously-posted thread object, the object action and the tracking list.

2. The method of claim 1 wherein creating the new thread object includes assigning values to at least one of the following attributes associated with the new thread object: thread object identifier, request timestamp, requesting user, one or more mentioned users, previously-posted thread object identifier, text message and voice message.

3. The method of claim 1 wherein creating the new thread object of the type data file object includes assigning values to at least one of the following attributes associated with the new thread object: data file identifier, data file location and data file format.

4. The method of claim 1 wherein creating the new thread object of the type document page object includes assigning values to at least one of the following attributes associated with the new thread object: one or more page numbers, document file identifier, document file location, and document file format.

5. The method of claim 1 wherein creating the new thread object of the type document signature object includes assigning values to at least one of the following attributes associated with the new thread object: one or more signers, one or more signer statuses, signing order, document status, document file identifier, document file location, and document file format.

6. The method of claim 1 wherein creating the new thread object of the type meeting object includes assigning values to at least one of the following attributes associated with the new thread object: host, one or more invitees, date, time, duration, agenda, meeting identifier, phone number, universal resource locator, record setting, document file identifier, document file location, and document file format.

7. The method of claim 1 wherein creating the new thread object of the type message object includes assigning values to at least one of the following attributes associated with the new thread object: text message and voice message.

8. The method of claim 1 wherein creating the new thread object of the type page comment object includes assigning values to at least one of the following attributes associated with the new thread object: comment, page position, page number, document file identifier, document file location, and document file format.

9. The method of claim 1 wherein creating the new thread object of the type to-do object includes assigning values to at least one of the following attributes associated with the new thread object: description, one or more assignees, due date, reminder schedule, status, data file identifier, data file location and data file format.

10. The method of claim 1 wherein performing the object action includes assigning values to at least one of the following attributes associated with the object action: object action identifier, request timestamp, requesting user, one or more mentioned users, and previously-posted thread object identifier.

11. The method of claim 1 wherein performing the object action of the type annotate object action includes:
(a) performing the object action associated with a previously-posted thread object of the type document page object;
(b) assigning values to at least one of the following attributes associated with the object action: document file identifier, document file location, page, page position, annotation type and annotation; and
(c) performing one of the following types of annotate object actions: create annotation, delete annotation, edit annotation or view annotation.

12. The method of claim 1 wherein performing the object action of the type attachment object action includes:
(a) performing the object action associated with a previously-posted thread object of one of the following types: data file object, document page object, document signature object, meeting object, message object or to-do object;
(b) assigning values to at least one of the following attributes associated with the object action: data file identifier, data file location and data file format; and
(c) performing one of the following types of attachment object actions: attach data file, detach data file or open data file.

13. The method of claim 1 wherein performing the object action of the type bookmark object action includes:
(a) performing the object action associated with a previously-posted thread object of one of the following types: data file object, document page object, document signature object or message object;
(b) assigning values to at least one of the following attributes associated with the object action: bookmark location; and
(c) performing one of the following types of bookmark object actions: bookmark or remove bookmark.

14. The method of claim 1 wherein performing the object action of the type checklist object action includes:
(a) performing the object action associated with a previously-posted thread object of one of the following types: data file object, document page object, document signature object, message object or to-do object;
(b) assigning values to at least one of the following attributes associated with the object action: one or more subtasks, one or more subtask statutes and title; and
(c) performing one of the following types of checklist object actions: create checklist, create checklist from checklist template, delete checklist, edit checklist, save checklist as template, or view checklist.

15. The method of claim 1 wherein performing the object action of the type clip object action includes:
(a) performing the object action associated with a previously-posted thread object of the type document page object;
(b) assigning values to at least one of the following attributes associated with the object action: audio or video data file identifier, audio or video data file location, and audio or video file format; and
(c) performing one of the following types of clip object actions: attach clip, detach clip or open clip.

16. The method of claim 1 wherein performing the object action of the type comment object action includes:
(a) performing the object action associated with a previously-posted thread object of one of the following types: data file object, document page object, document signature object, page comment object, meeting object or to-do object;
(b) assigning value to the following attribute associated with the object action: comment; and
(c) performing one of the following types of comment object actions: create comment, delete comment, edit comment or view comment.

17. The method of claim 1 wherein performing the object action of the type due date object action includes:
(a) performing the object action associated with a previously-posted thread object of any type;
(b) assigning values to at least one of the following attributes associated with the object action: text message, voice message, due date, status, and one or more notification settings; and
(c) performing one of the following types of due date object actions: create due date, delete due date, edit due date or view due date.

18. The method of claim 1 wherein performing the object action of the type meeting object action includes:
(a) performing the object action associated with a previously-posted thread object of the type meeting object;
(b) assigning values to at least one of the following attributes associated with the object action: text message, voice message, and one or more access methods; and
(c) performing one of the following types of meeting object actions: delete meeting, edit meeting, join meeting, record meeting, start meeting or view meeting.

19. The method of claim 1 wherein performing the object action of the type signature object action includes:
(a) performing the object action associated with a previously-posted thread object of the type document signature object;
(b) assigning values to at least one of the following attributes associated with the object action: one of one or more signers, and one of one or more signer responses; and
(c) performing one of the following types of signature object actions: accept signer role, decline signer role, and sign document.

20. The method of claim 1 wherein performing the presenting of the type to-do object action includes:
(a) performing the object action associated with a previously-posted thread object of the type to-do object;
(b) assigning values to at least one of the following attributes associated with the object action: one or more to-do object attributes, and one or more to-do object attribute values; and
(c) performing one of the following types of to-do object actions: delete to-do, edit to-do or view to-do.

21. The method of claim 1 wherein performing the presenting a tracking list to the user includes:
(a) assigning values to at least one of the following attributes associated with presenting a tracking list: request identifier, request timestamp and message thread identifier;
(b) retrieving thread objects associated with the requesting user in the message thread; and
(c) presenting the retrieved thread objects to the user in the tracking list.

22. A system comprising:
a processor;
a user request receipt logic that is configured to receive a request from a user of one or more users with respect to at least one of a message thread of one or more message threads and a thread object, the thread object being either a new thread object or a previously-posted thread object of one or more previously-posted thread objects in a message thread, the request being one of create thread object, perform object action, post thread object, post object action, present message thread, or present tracking list;
a thread object creation logic that is configured to create a new thread object being one of the following types:
(i) data file object,
(ii) document page object,
(iii) document signature object,
(iv) meeting object,
(v) message object,
(vi) page comment object or
(vii) to-do list object;
an object action performing logic that is configured to perform an object action with respect to a previously-posted thread object of one or more previously-posted thread objects in a message thread being one of the following types:
(i) annotate object action,
(ii) attachment object action,
(iii) bookmark object action,
(iv) checklist object action,
(v) clip object action,
(vi) comment object action,
(vii) due date object action,
(viii) meeting object action,
(ix) signature object action or
(x) to-do object action;
a thread object posting logic that is configured to post a new thread object to a message thread either: (i) unassociated with any previously-posted thread object in a message thread, or (ii) associated as a reply with a previously-posted thread object of one or more previously-posted thread objects in a message thread;
an object action posting logic that is configured to post an object action associated with a previously-posted thread object of one or more previously-posted thread objects in a message thread;
a message thread presenting logic that is configured to present a message thread, including one or more thread objects presented in conjunction with any associated replies and object actions, to a user;
a tracking list presenting logic that is configured to present a tracking list, including any thread objects associated with a user in a message thread, to a user; and
a message thread storing logic that is configured to store, a message thread and at least one of a new thread object, a previously-posted thread object, an object action and a tracking list.

23. A non-transitory, computer-readable medium storing program instructions that, when executed by a processor, cause the processor to perform the method of:
receiving, by a message thread workflow service, a request from a user of one or more users with respect to at least one of a message thread of one or more message threads and a thread object, the thread object being either a new thread object or a previously-posted thread object of one or more previously-posted thread objects in the message thread, the request being one of create thread object, perform object action, post thread object, post object action, present message thread, or present tracking list;
executing, by the message thread workflow service, the request by:
(a) creating the new thread object being one of the following types:
(i) data file object,
(ii) document page object,
(iii) document signature object,
(iv) meeting object,
(v) message object,
(vi) page comment object or
(vii) to-do list object;
(b) performing an object action associated with the previously-posted thread object in the message thread, the object action being one of the following types:
(i) annotate object action,
(ii) attachment object action,
(iii) bookmark object action,
(iv) checklist object action,
(v) clip object action,
(vi) comment object action,
(vii) due date object action,
(viii) meeting object action,
(ix) signature object action or
(x) to-do object action;
(c) posting the new thread object to the message thread either: (i) unassociated with any previously-posted thread object in the message thread, or (ii) associated as a reply with a previously-posted thread object of one or more previously-posted thread objects in the message thread;
(d) posting an object action associated with the previously-posted thread object to the message thread;
(e) presenting the message thread to the user, the message thread including one or more thread objects presented in conjunction with any associated replies and object actions; or
(f) presenting a tracking list to the user, the tracking list including any thread objects associated with the user in the message thread; and
storing, at the message thread workflow service, the message thread and at least one of the new thread object, the previously-posted thread object, the object action and the tracking list.
